(19) United States
(12) Patent Application Publication
(10) Pub. No.: US 2008/0060400 A1
(43) Pub. Date: Mar. 13, 2008

(54) MULTIFUNCTION LOCK WITH INDICATOR AND MECHANISM FOR RELOCKING WITHOUT KEY

(75) Inventors: Renny Tse-Haw Ling, Chung-Ho City (TW); Yung-Li Kuo, Chung-Ho City, Taipei County (TW)

Correspondence Address: SHERIDAN ROSS PC, 1560 BROADWAY, SUITE 1200, DENVER, CO, 80202, US

(73) Assignee: SINOX COMPANY LTD., Chung-Ho City (TW)

(21) Appl. No.: 11/854,770

(22) Filed: Sep. 13, 2007

Related U.S. Application Data
(60) Provisional application No. 60/941,780, filed on Jun. 4, 2007.
(60) Provisional application No. 60/896,894, filed on Mar. 23, 2007.
(60) Provisional application No. 60/844,564, filed on Sep. 13, 2006.

(51) Int. Cl. E05B 35/00; E05B 11/00

(52) U.S. Cl. 70/344; 70/389

(57) ABSTRACT

In accordance with at least one embodiment of the present disclosure, a lock is provided with a key lock mechanism and the lock has the ability to be relocked after the key lock mechanism has been opened and the key withdrawn from the key lock. Embodiments of the present disclosure may include a zipper lock with lock tongues that engage openings in zipper pulls of an article to be locked, a padlock, a strap lock, and a hard luggage lock. Embodiments of the present disclosure may also include an indicator for signaling that the key lock mechanism has been opened by a key. Embodiments of the disclosure may also include indicia for signaling that the lock is of the type which allows the lock to be relocked with the key removed from the key way of the key lock. Alternatively, embodiments of the disclosure may include a retaining function for retaining the key in the lock until the key lock mechanism is returned to a locked state.

### CROSS REFERENCE TO RELATED APPLICATIONS

The present application claims the benefit of U.S. Provisional Patent Application Nos. 60/844,564, filed Sep. 13, 2006, 60/896,894, filed Mar. 23, 2007, and 60/941,780, filed Jun. 4, 2007, the entire contents of which are incorporated herein by reference.

### BACKGROUND OF THE INVENTION

1. Field of the Invention

The present invention relates to a multifunction lock mechanism. More specifically, it relates to a lock which may be opened by either the owner of the lock or by an authorized security entity, such as the Transportation Security Administration (TSA), using an authorized override or master key. Typically, but not necessarily, such locks have two different lock mechanisms, one that is used by the lock owner and one that is used by the authorized security entity, normally a key lock mechanism. The two lock mechanisms may operatively control a single latching or engaging mechanism or they may operatively control distinct latching or engaging mechanisms. In general terms, one embodiment of the present invention permits the lock to be relocked after it has been opened by the authorized security entity using the key locking mechanism, but with the key removed from the key way of the locking mechanism. The lock may also include an indicator that is activated if the authorized master key is used to open the lock or if an unauthorized third party has tampered with or attempted to open the lock. The inventions of the present application may be used with virtually any type of lock, including detachable locks such as padlocks and strap locks, and locks that are integral with a piece of luggage, brief case or similar articles, such as zipper locks and built-in hard-sided luggage locks. In addition, the present invention also comprises indicia on the lock itself, which signals to the user that the lock is of the type that may be opened with a key, but relocked without the key. Furthermore, the present invention may comprise a mechanism for preventing removal of a key used to unlock the lock until the key is positioned in a locked position.

2. Description of the Prior Art

In U.S. Pat. No. 5,557,954, a zipper lock positioned on one side of a zipper for locking a pull-tab of the zipper is disclosed. The content of U.S. Pat. No. 5,557,954 is incorporated herein by reference in its entirety. The zipper lock has a combination lock mechanism. The combination lock mechanism includes a plurality of dials exposed on one side of the zipper lock. By moving the dials, the combination lock mechanism is locked or unlocked. The advantage of the combination lock is that the user can unlock it without any special tools or keys as long as he remembers the combination code. However, if the user forgets the combination code, the zipper lock can only be unlocked through trial and error, or by destructive means.

When TSA assumed responsibility of airport security in accordance with the Homeland Security Act, the need arose for TSA agents to have a means of opening locked luggage without destruction of luggage locks used by the luggage owner to safeguard the contents. This need has resulted in the manufacture, sale and use of a variety of locks with dual opening mechanisms, namely, a combination mechanism for use by the luggage owner and a key mechanism for use by TSA agents with a specially designed master or override key not available to anyone else, including the luggage owner. Specifically, to accommodate the security need of travelers while also accommodating the need of government employees to quickly and easily open and inspect selected and/or suspect bags, locks may be utilized by travelers for locking their luggage while allowing government or authorized personnel the ability to nondestructively open the locks. More particularly, if a traveler's locked bag is inspected by TSA personnel, the lock can be opened for inspection using an over-ride key that is purportedly made available only to government inspectors. Following inspection, it is intended that the bag will be relocked by the authorized inspector.

U.S. Pat. No. 6,912,880 describes a zipper lock having a combination lock mechanism and a key lock mechanism. The content of U.S. Pat. No. 6,912,880 is incorporated herein by reference in its entirety. The combination lock mechanism is used by the owner of the lock to unlock and lock the lock, while the key lock mechanism allows a TSA agent to unlock the lock with a key.

Unfortunately, it is now reported that TSA agents are not relocking locks following inspection, the keys used by TSA agents are finding their way into the possession of unauthorized persons who use the key to access the contents of luggage, or TSA personnel are stealing contents from the luggage. Regarding the first problem, failure to relock the baggage lock following an inspection, in many instances the TSA agent opens a lock using the authorized key and then removes the key from the lock during inspection of the luggage. This may be because a single agent possesses the only authorized key while other agents conduct the inspection to thereby limit access to the keys. The authorized inspector may also purposefully and as a matter of routine remove the key prior to inspection to prevent absent mindedly leaving the key in the lock. It also may be for efficiency reasons, or due to other reasons.

Regardless of the reason, many TSA-type locks only permit removal of the authorized key if the key locking mechanism is in the locked position. However, if the key is removed with the key lock with the key locking mechanism in the locked position and before the latching or engaging mechanism reengages the complementary article to be latched or engaged, then the latching or engaging mechanism is locked in the locked position and cannot reengage the complementary article to be relatched or reengaged without inserting the key into the key locking mechanism and positioning the key locking mechanism in an unlocked position. Thus, if a TSA agent using an authorized key unlocks a lock and removes the key from the lock, the key will need to be reinserted into the lock and the key lock positioned in an unlocked state in order to relock the piece of luggage. As is the case with the lock in the '880 patent, the lock cannot be relocked without the key. The zipper pulls can only be reinserted into the lock, and the lock relocked, by first reinserting the authorized key into the key lock mechanism and positioning the key in an unlocked position. The latching or engaging mechanism of the lock will not engage and secure the zipper pulls if the key locking mechanism is locked. This same problem occurs with other varieties of locks. For example, see U.S. Pat. No. 6,877,345, which discloses a TSA-sanctioned padlock. The key lock mechanism of this lock cannot be relocked without using the key. Accordingly, it is believed that from an inspection efficiency standpoint, it is more efficient and timely for the TSA agent to return the luggage to the luggage handler or owner without taking the time to reinsert the key into the lock, unlock the key locking mechanism and relock the lock in a way that secures the luggage.

One potential solution to the foregoing problem would be to design key locks that permit the key to be removed from the key way with the key locking mechanism in an unlocked state. However, this solution creates a different problem. With the key removed from the key locking mechanism and the key locking mechanism in an unlocked state, even if the latching or engaging mechanism reengages the article to be locked, the locking mechanism is still in an unlocked state and the lock may be opened and the content of the luggage accessed. Activation of the latching or engaging member provides a false sense of security since the key locking mechanism is still in an unlocked position. To overcome this problem, the key must be reinserted into the key way and the key locking mechanism returned to the locked position after the article to be latched is properly positioned relative to the latch. This solution offers no efficiency or time savings and the TSA personnel are likely to leave the lock unlocked with the contents of the luggage accessible.

Accordingly, it would be advantageous to be able to relock any TSA-type lock without having to first reinsert the authorized key into the key lock mechanism. Indeed, as noted above, due to the extra effort required, TSA agents are likely to leave a bag unlocked, and therefore unsecured, following inspection, rather than take the additional time required to reinsert their override key to be able to relock the lock. Thus, there is a need for a lock that solves the foregoing problems and also provides an indicator that indicates to the owner of the lock that a key has been inserted into the key lock, such as by inserting an authorized TSA key into the key way or by an unauthorized person tampering with the lock. Alternatively, if a key lock mechanism is not capable of being relocked without the authorized key, there is also a need for a key lock which physically retains the key when it is turned to an unlocked position, and only allows removal of the key once it has been returned to a locked position. Various embodiments of the present invention address these needs.

### SUMMARY

In one embodiment of the invention, zipper locks are used to secure zipper pulls to prevent access to a container or article that uses a zipper as a closure mechanism. Typically, the zipper lock comprises a housing with receptacles or slots for receiving zipper pulls, wherein the zipper pulls are secured by locking tongues that latch or engage the zipper pulls once positioned in the receptacles or slots. The invention permits the zipper lock to be unlocked using an override key, and further permits the key to be removed and the lock relocked without use of the key. This feature is relevant, for example, to facilitate relocking of the lock following inspection by TSA agents. If the agent does not need to reinsert the key into the lock to accomplish relocking of the lock following inspection, the probability of the agent relocking the lock, and thereby securing the owner's luggage, is increased.

At least one embodiment of the present invention also comprises a key lock that includes a mechanism for indicating whether the key lock has been opened using an authorized key or whether a key or other object has been inserted into the key way of the key lock in an attempt to unlock the key lock. For example, when traveling, luggage is often out of the possession and control of the owner. The insertion of a key or appropriately shaped object into the key lock cylinder of a lock of the present invention activates a warning indicator within the lock in a manner visible to the owner or user. As a result, when the owner retrieves his or her luggage, the owner is able to observe the indicator and determine if the key lock has been tampered with or perhaps opened by another. If the indicator has been activated, the owner may immediately assess the contents of the luggage and alert authorities as is appropriate. The indicator may be reset by the owner in one or more ways, for example, resetting the indicator using a separate lock mechanism such as a combination lock.

In a further embodiment of the invention, indicia of some kind is provided on the lock that alerts or signals to TSA agents that the lock may be relocked without inserting the TSA override key. This indicia will facilitate handling of luggage by TSA as it will distinguish locks that require reinsertion of the override key to accomplish relocking of the lock from locks that do not require the override key to relock the key. This should decrease inspection time and increase the probability of the lock being relocked, both of which are advantages to the owner. The indicia will also provide the same signal to prospective buyers of luggage locks and can be used by retailers for marketing purposes to distinguish locks having this feature from locks without this feature.

In yet a further embodiment there is provided a lock which allows a TSA agent or other authorized individual to remove the key from the key lock mechanism only when the key is positioned in a locked state. This prevents the authorized person from removing the key when the lock is positioned in an unlocked state. In some types of locks, the latching member may reengage the article to be latched giving the impression the lock has been relocked and is secure. However, if the key lock is still positioned in an unlocked state, the latching member may still be released and the lock opened exposing the contents of the luggage to theft in the interim. For example, in the case of a zipper pull lock, the zipper pulls may be reinserted in the slots and engaged or latched by the latching tongue, but the buttons used to move the latching tongue to an unlocked position may still be active because the key locking mechanism is in an unlocked state. In this embodiment, a retaining function precludes withdrawal of the key from the key locking mechanism unless the key locking mechanism is in its locked state.

It will be appreciated by those skilled in the art that the concepts presented herein are applicable for use with a variety of locking mechanisms, including locks used with luggage and travel items and locks not associated with luggage or travel items. It is also to be understood that the present invention includes a variety of different versions or embodiments, and this Summary is not meant to be limiting or all-inclusive. That is, this Summary provides general descriptions of certain embodiments, but may also include more specific descriptions of certain other embodiments. For example, the concepts addressed herein are applicable to a variety of lock styles including but not limited to zipper pull locks, locks used with hard-sided luggage, strap locks and padlocks. It is further contemplated, though not required, that the locks have two separate unlocking mechanisms, one for the owner and one for an authorized inspector. Only one of these mechanisms need be a key operated mechanism although both could be key operated. Further to this point, the term key as it is used herein to refer to an authorized master key or override key is intended to include within its meaning and scope any unique tool only available to and used by authorized inspectors. Accordingly, various embodiments of the present invention are illustrated in the attached figures and described in the detailed description of the invention as provided herein and as embodied by the claims. It should be understood, however, that this Summary does not contain all of the aspects and embodiments of the present invention and that the invention as disclosed herein is and will be understood by those of ordinary skill in the art to encompass obvious improvements and modifications thereto.

Additional advantages of the present invention will become readily apparent from the following discussion, particularly when taken together with the accompanying drawings.

### BRIEF DESCRIPTION OF THE DRAWINGS

FIG. 1 is a schematic diagram illustrating a lock in accordance with an embodiment of the present invention;

FIG. 2 and FIG. 3 are plan views of the lock shown in FIG. 1;

FIG. 4 is an exploded view of a sleeve and a lock housing shown in FIG. 1;

FIG. 5 to FIG. 18 are schematic diagrams illustrating different embodiments of the lock shown in FIG. 1;

FIG. 19A is a side elevation view of a lock comprising a position fixing block for the lock tongue, the zipper pulls having not engaged the lock tongues;

FIG. 19B is a perspective view elements shown in FIG. 19A (without zipper pulls);

FIG. 19C is a side elevation view of an interior section of the position fixing block shown in FIG. 19B;

FIG. 19D is a side elevation view of the device of FIG. 19A with zipper pulls being advanced into the lock;

FIG. 19E is a perspective view of some of the elements shown in FIG. 19D (without zipper pulls);

FIG. 19F is a side elevation view of the device of FIG. 19A with the zipper pulls being advanced into the lock in the absence of a position fixing block;

FIG. 19G is a perspective view of some of the elements shown in FIG. 19F (without zipper pulls);

FIG. 19H is a side elevation view of the device of FIG. 19A with zipper pulls advanced and locked by the lock tongues;

FIG. 19I is a perspective view of some of the elements shown in FIG. 19C (without zipper pulls);

FIGS. 20A-20K are various views of certain elements of embodiments having a position fixing block;

FIG. 21 is a perspective view of a zipper lock in accordance with an embodiment of the present invention, the zipper lock including an indicator;

FIG. 22 is an exploded view of the zipper lock shown in FIG. 21;

FIG. 23 is a partially exploded view of the zipper lock shown in FIG. 21;

FIG. 24 is an exploded view of some of the elements of the zipper lock shown in FIG. 21;

FIG. 25 is another exploded view of the elements of FIG. 24;

FIG. 26 is yet another exploded view of the elements of FIG. 24;

FIG. 27 is a schematic view of a padlock in accordance with another embodiment of the present invention;

FIG. 28 is a plan view of a strap lock in accordance with another embodiment of the present invention;

FIG. 29 is a side view of the strap lock shown in FIG. 28;

FIG. 30 is a schematic view of the strap lock shown in FIG. 28;

FIG. 31 is another schematic view of the strap lock shown in FIG. 28;

FIG. 32 is a schematic view of a hard luggage lock in accordance with another embodiment of the present invention;

FIG. 33 is another schematic view of the hard luggage lock of FIG. 32;

FIG. 34 is a detailed view of the hard luggage lock of FIG. 32;

FIG. 35 is another detailed view of the hard luggage lock of FIG. 32;

FIG. 36 is a partially exploded view of the hard luggage lock of FIG. 32;

FIG. 37 is a detailed view of some of the elements of the hard luggage lock of FIG. 32;

FIGS. 38a and 38b are side views of some of the elements of the hard luggage lock of FIG. 32;

FIG. 39 is another detailed view of some of the elements of the hard luggage lock of FIG. 32;

FIGS. 40a and 40b are side views of some of the elements of the hard luggage lock of FIG. 32;

FIG. 41 is another a partially exploded view of the hard luggage lock of FIG. 32;

FIG. 42 is another partially exploded view of the hard luggage lock of FIG. 32;

FIG. 43 is another schematic view of the hard luggage lock of FIG. 32;

FIGS. 44a-44d are views from different perspectives of the key lock mechanism of the hard luggage lock of FIG. 32 in a first position;

FIGS. 45a-45d are views from different perspectives of the key lock mechanism of the hard luggage lock of FIG. 32 in a first position;

FIG. 46 is a perspective view of a lock in accordance with another embodiment of the present invention;

FIG. 47 is a perspective view of the lock of FIG. 46 once the key has been rotated to an unlocked position allowing the zipper pull to be removed;

FIG. 48 is another perspective view of the lock of FIG. 46 once the key has been rotated back to a locked position;

FIG. 49 is another perspective view of the lock of FIG. 46 once the key has been rotated back to a locked position, thereby allowing the key to be removed; and

FIG. 50 is another perspective view of the lock of FIG. 46 once the zipper pull has been reengaged with the lock.

The drawings are not necessarily to scale.

### DETAILED DESCRIPTION

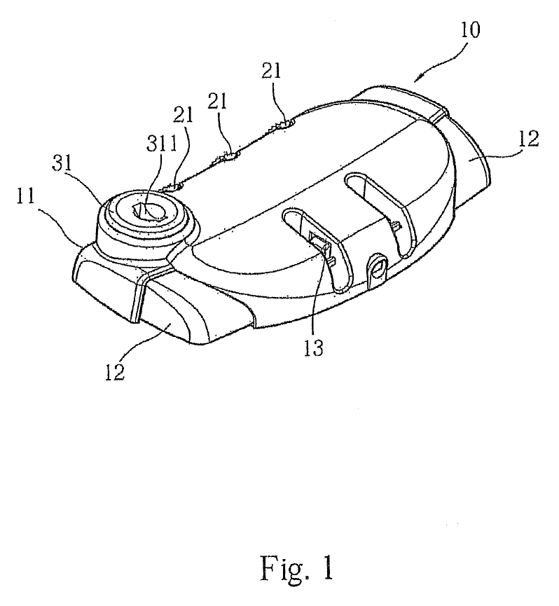

Referring now to FIG. 1 to FIG. 3, the illustrated zipper lock includes a lock body 10, a first lock mechanism 20 and a second lock mechanism 30. The first lock mechanism 20 is a combination lock mechanism, while the second lock mechanism 30 is a key lock mechanism.

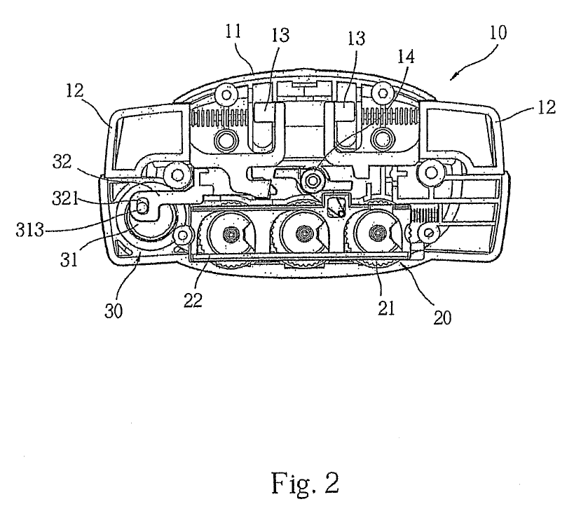

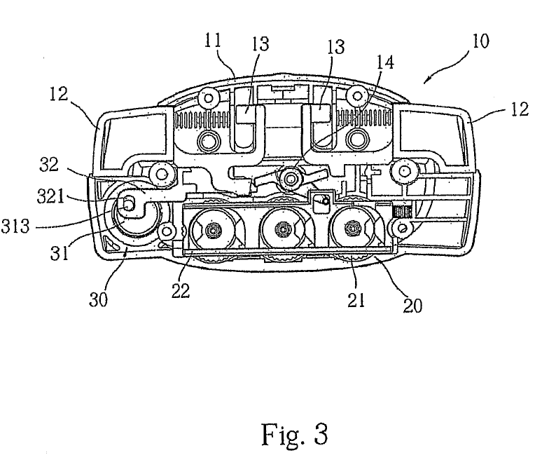

The lock body 10 includes a lock housing 11, two activation members or push-buttons 12, and engaging or latching members such as lock tongues 13. The push-buttons 12 and the lock tongues 13 are interconnected and are positioned at least partially in the lock housing 11. The push-buttons 12 can be depressed by a force, such as by a user's fingers, so that each lock tongue 13 is shifted to a releasing position (as shown in FIG. 2). Releasing the buttons may cause each lock tongue 13 to return to a locking position (as shown in FIG. 3) or the lock tongues may temporarily be held in an unlocked state.

Although shown with two receptacles for two zipper pulls, the zipper lock embodiments of the present invention also encompass zipper locks for zippers having a single zipper pull. In addition, the lock of the present invention may be used with pulls other than for zippers, such as, by way of example and not limitation, draw cords and/or pulls for seals associated with waterproof bags.

The lock body 10 further includes a stopping member 14. The stopping member 14 moves either in a linear motion or a rotary motion relative to the lock housing 11. The stopping member 14 can be shifted to a first position, which constrains the lock tongue 13 in the locking position (as shown in FIG. 3), or the stopping member 14 can be shifted to a second position, which permits movement of the lock tongue 13 (as shown in FIG. 2).

The first lock mechanism 20 is a combination lock mechanism including a plurality of dials 21 and a shifting plate 22 positioned in the lock body 10. It should be appreciated that the first lock mechanism may be another style of lock mechanism, such as a key mechanism, but in this embodiment it is shown as a combination mechanism. The shifting plate 22 can be shifted to an unlocking position (as shown in FIG. 2) or a locking position (as shown in FIG. 3) by appropriately setting the plurality of dials 21. The shifting plate 22 and the stopping member 14 operate interactively. When the shifting plate 22 is shifted toward the locking position, the stopping member 14 will be moved correspondingly to the first position so that the lock tongue 13 is constrained. On the other hand, when the shifting plate 22 is shifted back to the unlocking position, the stopping member 14 will be moved correspondingly to release the constraint of the lock tongue 13. Since the technology of combination lock mechanism is well known, further details are not repeated here.

In accordance with at least one embodiment of the present invention, the zipper lock may include a second lock mechanism 30. The second lock mechanism 30 also unlocks. Thus, the lock of this embodiment may be unlocked by either the first lock mechanism 20 or the second lock mechanism 30. As illustrated, the second lock mechanism 30 is a key lock mechanism that may be utilized by an authorized inspector. As shown, the second lock mechanism 30 has a sleeve 31 and a linking member 32 in relation with each other. The sleeve 31 further includes a keyhole 311 for allowing a key “K” to be inserted and rotated such that the linking member 32 is shifted and forces the stopping member 14 to change positions. When the key “K” is not inserted into the keyhole 311, the sleeve 31 and the lock housing 11 are not allowed to move relative to each other. Once the key “K” is inserted into the keyhole 311, the sleeve 31 is free to rotate relative to the lock housing 11.

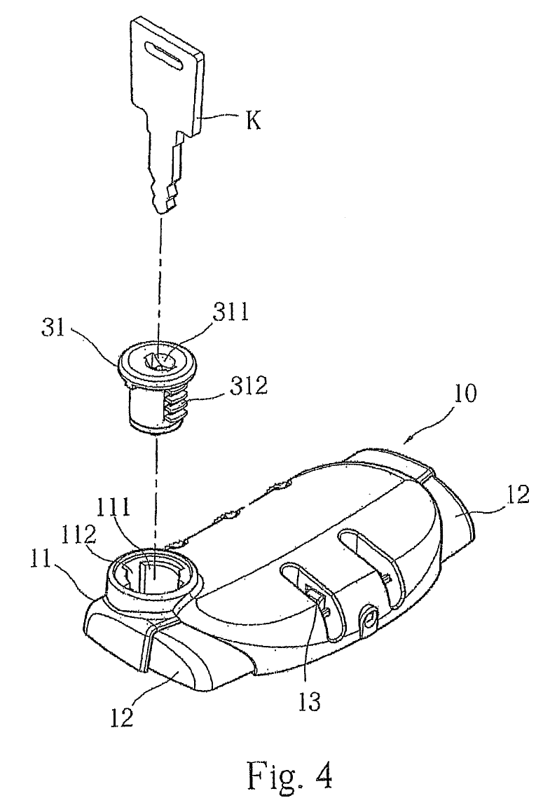

Referring now to FIG. 4, an exploded view of the sleeve 31 and the lock housing 11 is shown. The sleeve 31 includes a plurality of discs 312 which protrude out of the sleeve 31 in normal condition. Accordingly, the lock housing 11 includes a cavity 111 having a groove 112 for receiving the discs 312. The sleeve 31 is not free to rotate once the discs 312 are inserted into the groove 112. When the key “K” is inserted into the keyhole 311, the discs 312 are drawn back or retracted, and the sleeve 31 is free to rotate relative to the lock housing 11.

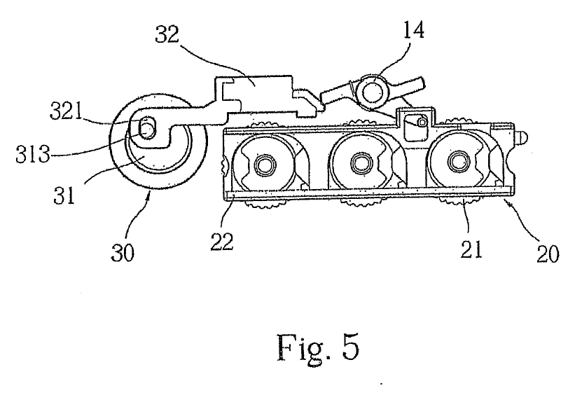

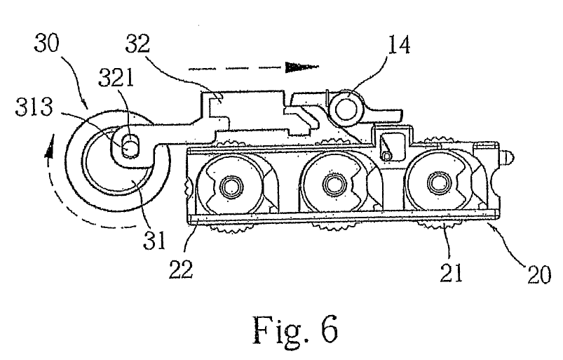

The sleeve 31 further includes a protrusion 313, while the linking member 32 includes a receptacle, opening or oblong hole 321 for receiving the protrusion 313. FIGS. 5 and 6 illustrate schematic diagrams showing how the sleeve 31 and the linking member 32 interact. As shown in FIG. 5 and FIG. 6, the protrusion 313 is in an eccentric position in the oblong hole 321 such that the linking member 32 will move linearly when the sleeve 31 rotates by movement of the key K. When the stopping member 14 is driven by the shifting plate 22 to shift to the first position, the linking member 32 is able to shift the stopping member 14 to the second position so that the constraint of the lock tongue 13 is released. Therefore, as previously noted, the unlocking action of the lock may be performed by utilizing either the combination lock mechanism or the key lock mechanism.

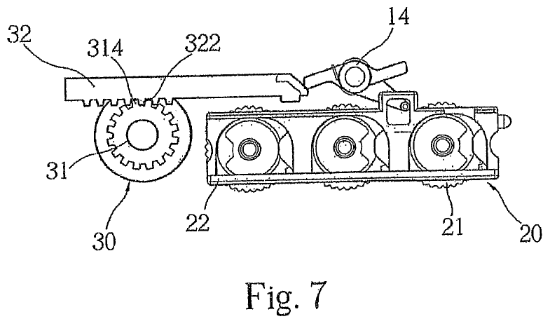

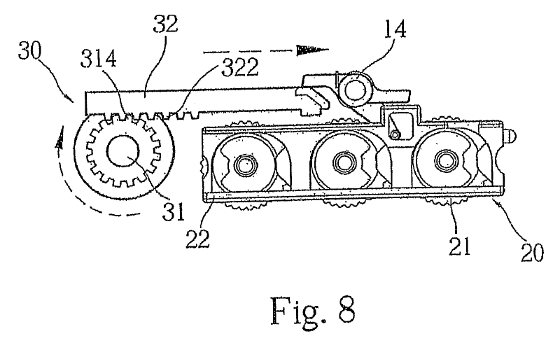

Referring now to FIGS. 7 and 8, schematic diagrams of another embodiment of the present invention are depicted. The sleeve 31 and the linking member 32 respectively have gears 314 and 322 meshing with each other. Therefore, the sleeve 31 and the linking member 32 operate by means of mesh transmission, similar to a rack and pinion structure. The stopping member 14 is similarly rotated between a locked position (FIG. 7) and unlocked position (FIG. 8) by linear movement of linking member 32.

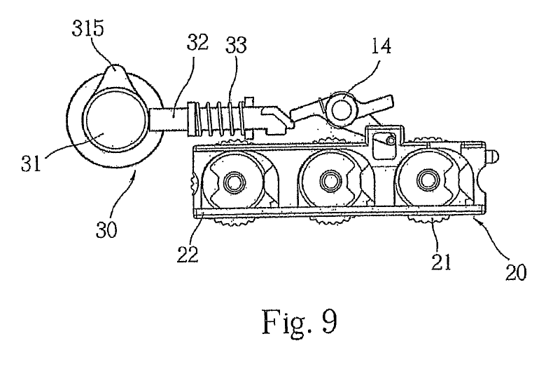

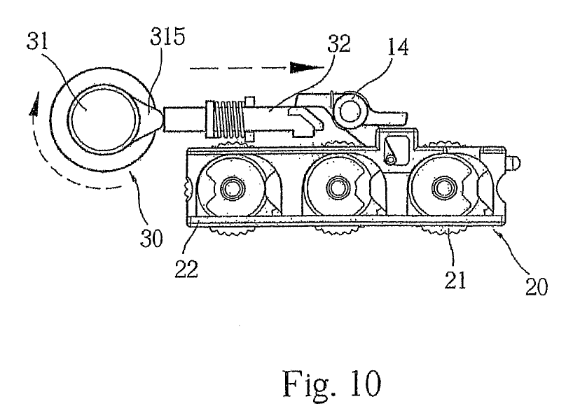

Referring now to FIGS. 9 and 10, schematic diagrams illustrating another embodiment of the present invention are depicted. The sleeve 31 has a cam 315 connected to the linking member 32 so that the sleeve 31 and the linking member 32 are operated correspondingly. In this embodiment, the linking member 32 further includes a resilient member 33, such as a spring in compression, for providing the linking member 32 with a recovering ability such that the linking member 32 and the cam 315 remain in contact. As described above in regards to FIGS. 5 and 6, linear movement of linking member 32 moves the stopping member 14 between a locked position (FIG. 9) and an unlocked position (FIG. 10).

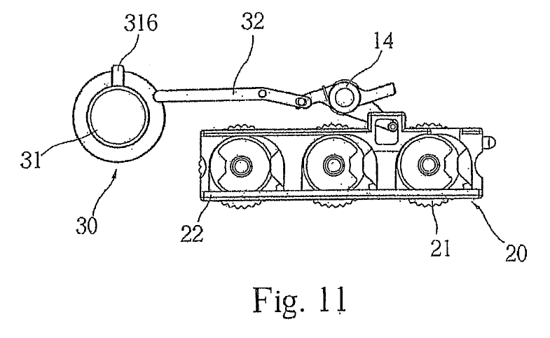

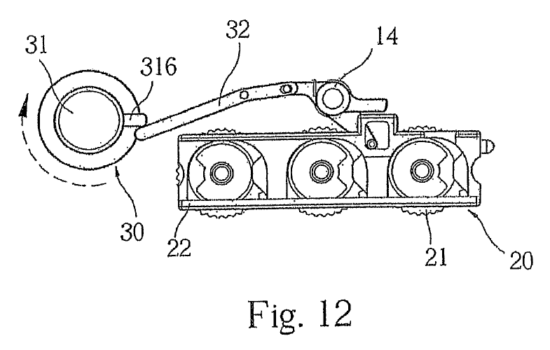

Referring now to FIGS. 11 and 12, schematic diagrams illustrating another embodiment of the present invention are depicted. The linking member 32 is pivotally connected with the housing and positioned adjacent the sleeve 31 and the stopping member 14, and the sleeve 31 includes a lever 316. The lever 316 triggers one end of the linking member 32, and thereby the opposite end of the linking member 32 forces the stopping member 14 to the second position. It is worth noticing that the linking member 32 and the stopping member 14 may be connected to each other. For example, as shown, the linking member 32 is connected to the eccentric position of the stopping member 14.

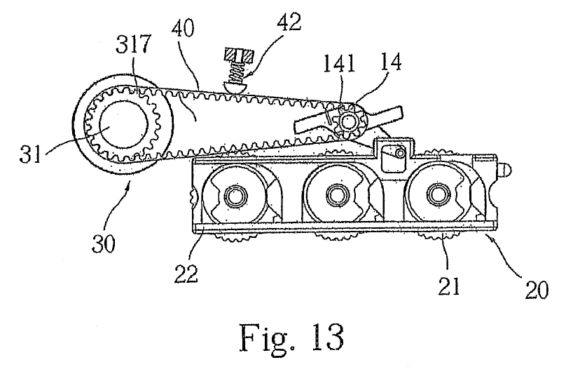

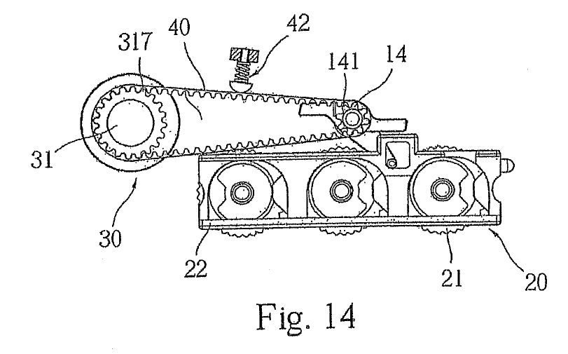

Referring now to FIGS. 13 and 14, schematic diagrams illustrating yet another embodiment of the present invention are depicted. The sleeve 31 and the stopping member 14 may be connected by means of a flexible transmission member 40. The flexible transmission member 40 is a closed loop member, such as a belt, a rack, or a chain, connected to both the sleeve 31 and the stopping member 14. Therefore, the sleeve 31 and the stopping member 14 are moved by frictional force. In addition, if the sleeve 31, the stopping member 14, and the flexible transmission member 40 include respective gears 317, 141, and gear teeth 41, then the sleeve 31 and the stopping member 14 can be moved by means of mesh transmission. Further, the flexible transmission member 40 can be modulated by a tension modulator 42 for adjusting the tightness.

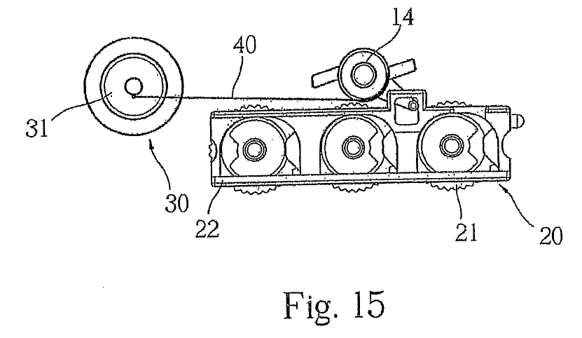

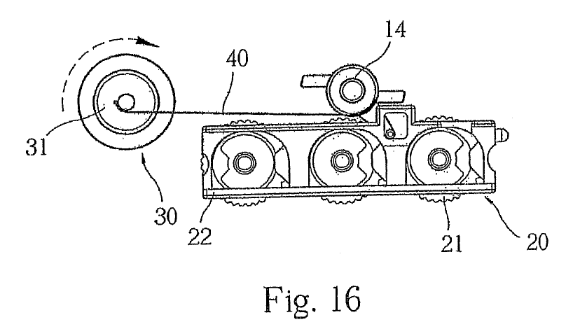

Referring now to FIGS. 15 and 16, schematic diagrams illustrating another embodiment of the present invention are depicted. The flexible transmission member 40 may also be a toothed belt connected to both the sleeve 31 and the stopping member 14. Therefore, the sleeve 31 and the stopping member 14 are moved correspondingly by the movement of the belt.

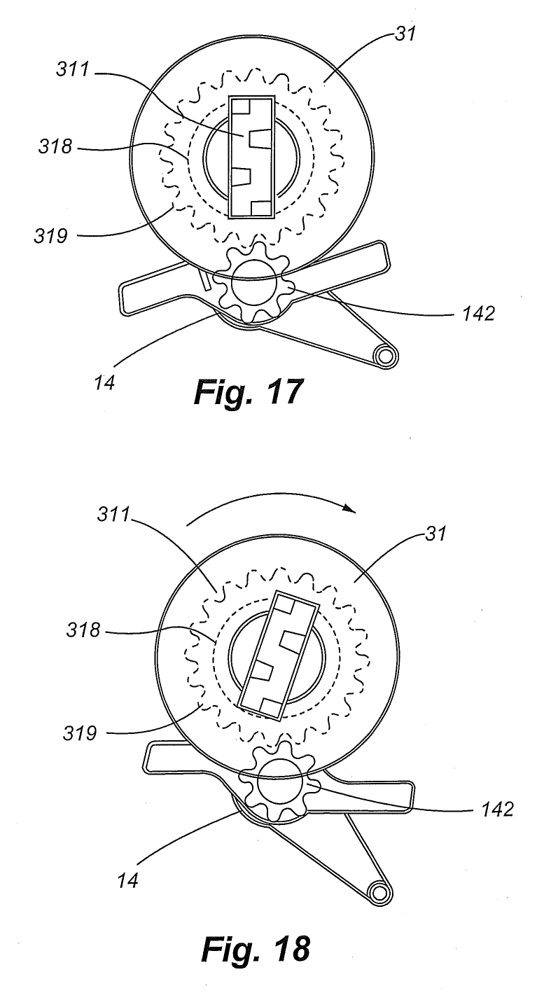

Referring now to FIGS. 17 and 18, schematic diagrams illustrating still another embodiment of the present invention are depicted. Differing from the other embodiments, the stopping member 14 is triggered directly by the sleeve 31 in this embodiment. The sleeve 31 includes an extension part 318 rotating simultaneously with the sleeve 31 and, in turn, connected gear 319. Gear 319 provides a direct rotational movement to complementary gear 142, causing stopping member 14 to pivot between a locked position (FIG. 17) and unlocked position (FIG. 18) depending upon the direction of rotation of the key K in keyhole 311 of the sleeve 31.

In accordance with embodiments of the present invention, a lock is provided for enabling zipper pulls Z to be reengaged by a latching member and the latching member locked without requiring the key K to be reinserted into the keyhole 311 or turning the key or the sleeve 31. More particularly, some embodiments of the present invention allow the lock to initially be set with the zipper pulls Z engaged and locked with the lock tongues 13 of the lock, and then the lock subsequently opened by the key lock (described in greater detail below), the key K removed, and thereafter the zipper pulls Z reinserted into the lock to reengage the lock tongues 13 and the lock tongues locked in a locked position, thereby allowing the zipper pulls to be relocked without reinserting and/or using the key K.

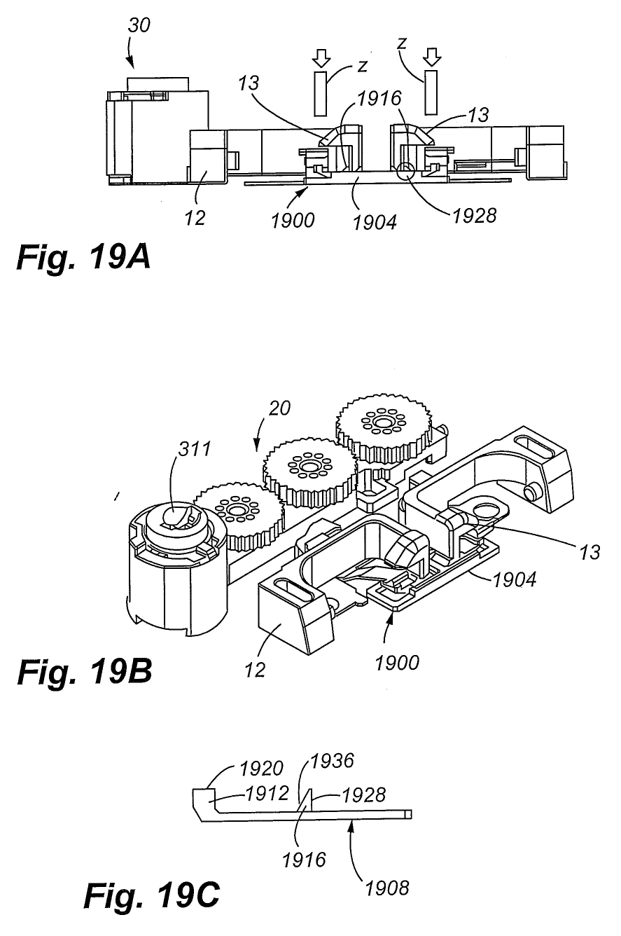

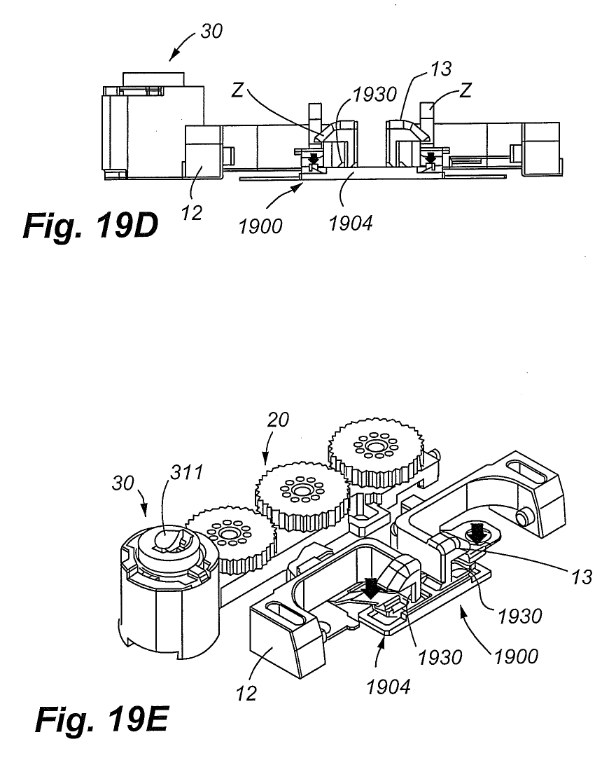

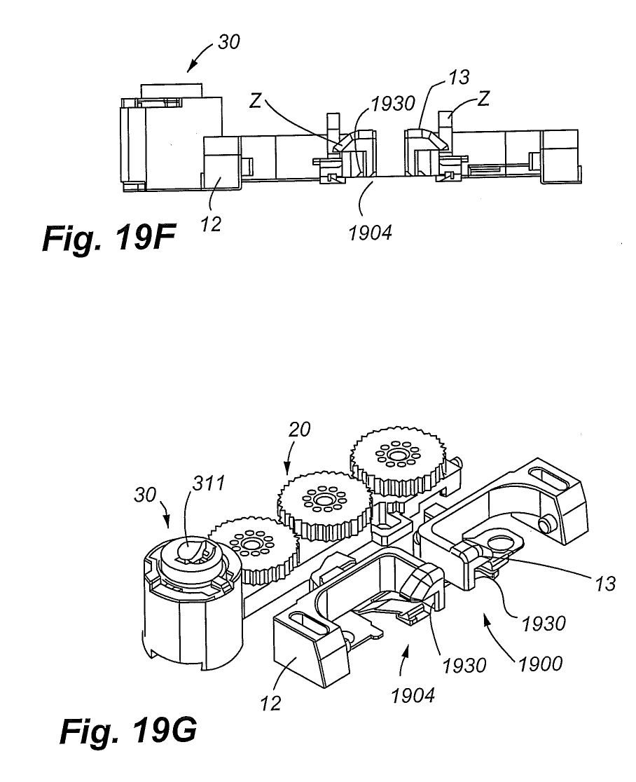

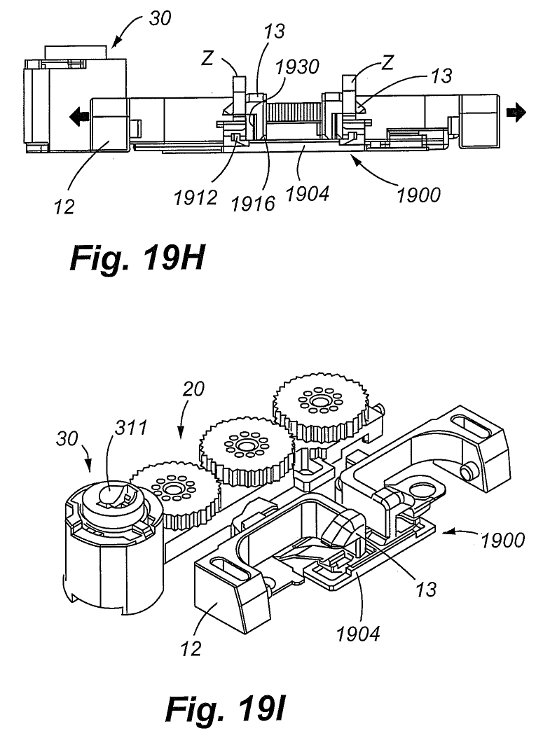

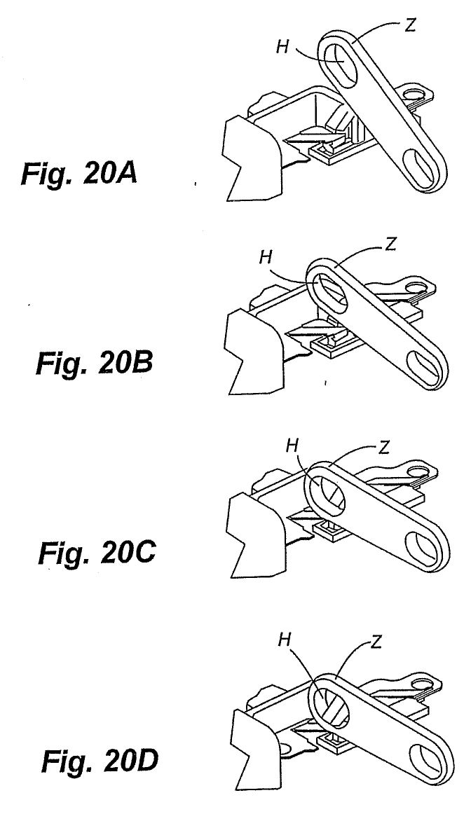

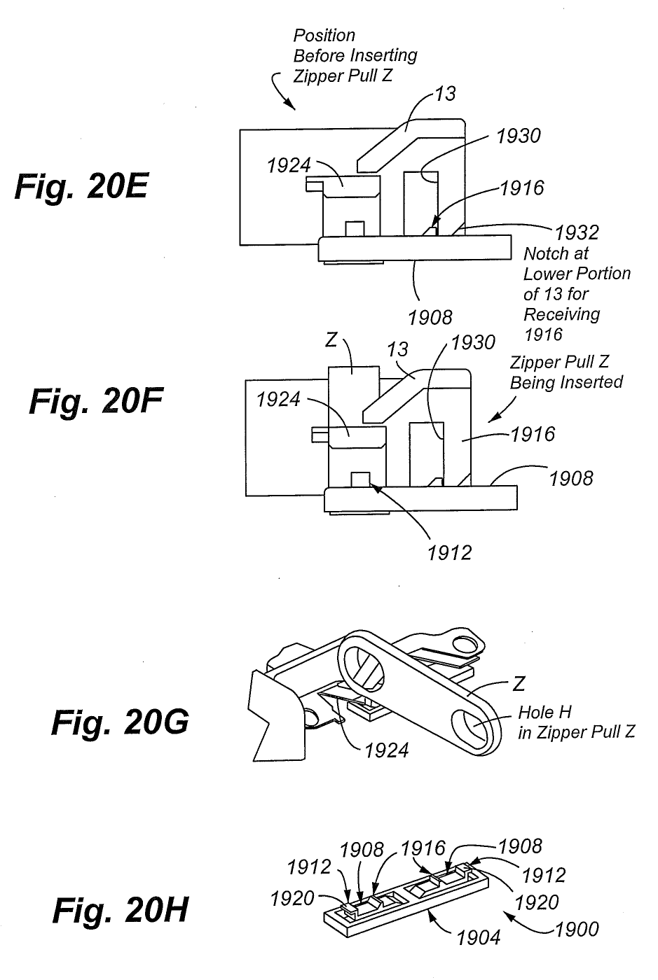

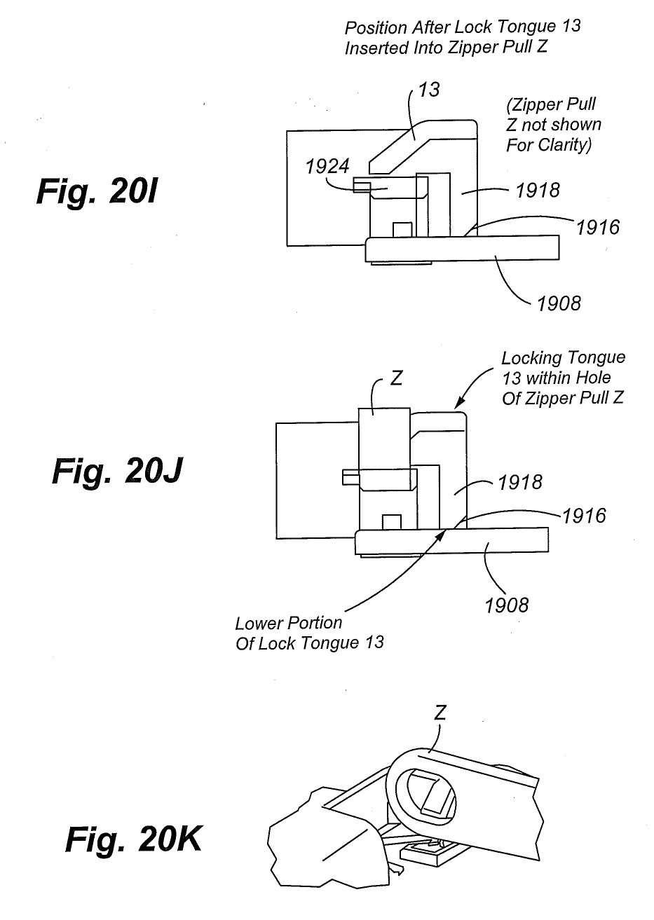

Referring now to FIGS. 19A-I and 20A-K, and in accordance with embodiments of the present invention, a blocking member or position fixing block 1900 is provided that resets the lock tongues 13 for receiving the zipper pulls Z after the key K has been removed from the second lock 30 (the key lock of FIG. 19A). The position fixing block 1900 preferably includes a frame 1904 that includes first and second biasing members 1908, where each of the first and second biasing members 1908 are configured for operatively interacting with a respective lock tongue 13 (See FIG. 20H). In accordance with embodiments of the present invention, the first and second biasing members 1908 are preferably leaf springs that include a first projection 1912 and a second projection 1916. Preferably, the first projection 1912 is located at or near an end of the biasing members 1908, such as below the location where the zipper pull Z is inserted into the lock. The second projection 1916 is located at an intermediate position along the length of the biasing members 1908, where the intermediate position allows the second projection 1916 to operatively interact with both sides of the lower portion 1918 of the lock tongue 13.

In accordance with at least one embodiment of the present invention, the first projection 1912 includes a contacting surface 1920 for engaging a biased lever or pop-up spring 1924 situated between the zipper pull Z and the contacting surface 1920 of the first projection 1912. When the zipper pull Z is advanced into the zipper pull locking receptacle of the lock, the zipper pull Z pushes the pop-up spring 1924 toward the first projection 1912 and causes the pop-up spring 1924 to contact the contacting surface 1920 of the first projection 1912. Movement of the first projection 1912 causes movement or deflection of the biasing member 1908 whereby the second projection 1916 is also moved to disengage or slip away from a lower portion of the lock tongue 13. That is, the second projection 1916 includes a retaining wall 1928 for holding a retaining surface 1930 of the lower portion 1918 of the lock tongue 13. The lock tongue 13 is biased to be inserted into the hole H of the zipper pull Z. When the biasing member 1908 is deflected by the zipper pull Z acting on the pop-up spring 1924, the retaining wall 1928 of the second projection 1916 disengages from the retaining surface 1930 of the lower portion 1918 of the lock tongue 13, whereby the lock tongue 13 moves into the hole H of the zipper pull Z to lock the zipper pull Z within the receptacles of the lock. Due to the lateral movement of the lock tongue 13, the second projection 1916 is then received or positioned within a notch 1932 on the lower portion 1918 of the lock tongue 13.

Embodiments incorporating the position fixing block 1900 enable the user to first set the lock by advancing a zipper pull Z within the lock to trigger the lock tongue 13 to engage the hole H of the of the zipper pull Z. The second lock mechanism 30 may then be used to unlock the lock. For example, a TSA agent may use an over-ride key to open the second lock mechanism 30. When the second lock mechanism 30 is unlocked, the push buttons 12 become active and may be advanced to move the lock tongue 13 out of the hole H of the zipper pull Z. In so doing, the zipper pull Z is unlatched or released and the pop-up spring 1924 pushes the zipper pull Z away from the lock tongue 13 and out of the locking receptacle, allowing the luggage or article associated with the zipper pull Z to be opened. The movement of the push buttons 12 to disengage the lock tongue 13 from the zipper pull Z also forces the lower portion 1918 of the lock tongue 13 to ride over the second projection 1916 causing the biasing member 1908 to deflect away from the lower portion 1918 of the lock tongue 13.

The second projection 1916 preferably includes a sloped or camming surface 1936 which engages and is complementary to a sloped surface formed by notch 1932 in the lower portion 1918 of the lock tongue 13. The interaction of the complementary sloped surfaces 1932, 1936 facilitate deflection of the biasing member 1908 due to the lateral movement of the lower portion 1918 of the lock tongue 13. Since the second projection 1916 resides on the biasing member 1908, the biasing member 1908 moves to accommodate the movement of the lock tongue 13. As a result, the lower portion 1918 of the lock tongue 13 moves from its locked position, where second projection 1916 is situated within the notch 1932, to an unlocked position where the retaining wall 1928 of the second projection 1916 engages the retaining surface 1930 of the lower portion 1918 of the lock tongue 13. In this position, the lock tongue 13 is biased to move into the locking position, but is prevented from doing so by the retaining wall 1928 acting on the retaining surface 1930. Thus, when the push buttons 12 are released, the biased lock tongue 13 moves back again toward the opening for the zipper pull Z; however, the retaining wall 1928 stops the lateral motion of the returning lock tongue 13 by contacting and holding the retaining surface 1930 of the lower portion 1918 of the lock tongue 13. Such advantageous positioning of the lock tongue 13 allows the key to be removed from the second lock 13, while then also allowing the lock to be relocked by simply reinserting the zipper pull Z into the lock. The zipper pull Z is readily relockable, even though the TSA agent may have removed the over-ride key. In other embodiments, the position fixing block 1900 may be removed (As shown in FIGS. 19F and 19G) and still allow the zipper pull Z to be relatched or reengaged with the lock tongue 13 and the lock relocked, as described in greater detail below.

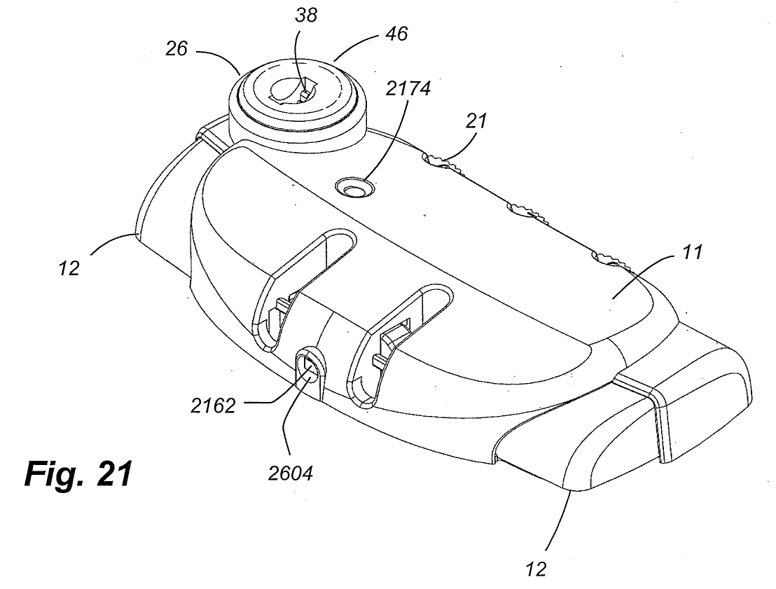

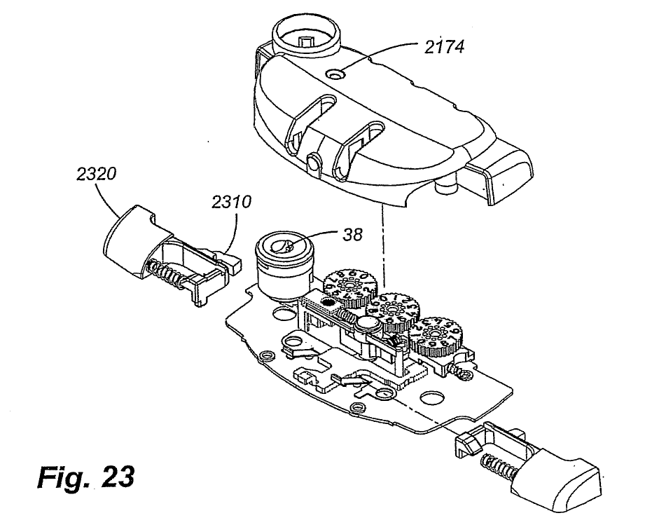

Referring now to FIG. 21 to FIG. 26, and in accordance with at least one embodiment of the present invention, a lock, such as a zipper lock shown in FIG. 21, includes a mechanism for indicating whether a key K or other object has been used to unlock the zipper lock. Similar to the previously described zipper locks, the zipper lock of the present embodiment includes a housing 11, two activation members or push-buttons 12, and latch members or lock tongues 13. In addition, the zipper lock of the present embodiment includes an activation member 2104 that resides within the housing 11 and includes a first member 2112 having an extension arm 2108 that is operatively associated with the second lock 30.

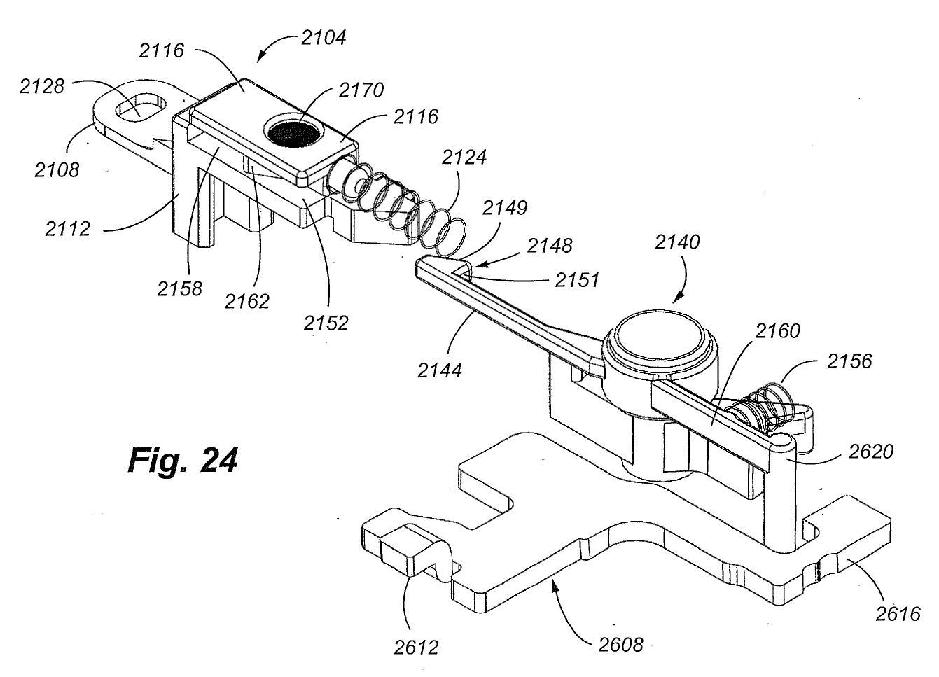

As best seen in FIG. 24, the activation member 2104 includes first member 2112 and second member 2116, wherein the second member 2116 comprises an indicator 2170. When the activation member 2104 is positioned in a first or normal position, the indicator 2170 would represent that the key lock or second lock 30 has not been used to open the zipper lock. However, the indicator 2170 includes a second position for indicating that the key lock or second lock 30 has been used to open the zipper lock.

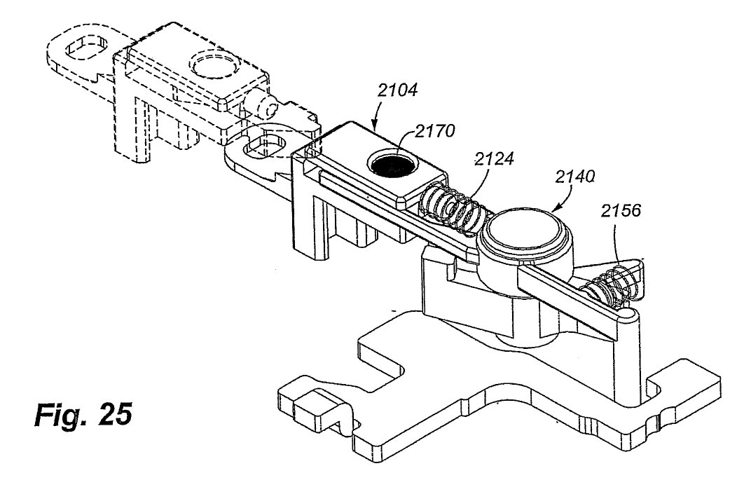

In accordance with at least one embodiment of the present invention, the activation member 2104 includes an oblong slot 2128 in the extension arm 2108 of the first member 2112 that is axially aligned with protrusion 313 extending from the sleeve 31 of the second lock 30 (as shown in FIG. 6). When a key K is inserted into the key way 38 and rotated, the sleeve 31 moves the activation member 2104 linearly to place the indicator 2120 in its second position (as shown in FIG. 25). As shown in FIG. 24, the activation member 2104 also includes a biasing member, such as a first compression spring 2124, located on or near one side of the activation member 2104. The first compression spring 2124 compresses as the activation member 2104 moves from the first position (FIG. 24) to the second position (FIG. 25).

When in the second position, the activation member 2104 is held in place by a retaining member 2140. More particularly, engagement between the activation member 2104 and retaining member 2140 is accomplished by way of a lever arm 2144 that comprises a projection 2148 at one distal end. The projection 2148 has a camming surface 2149 and a locking surface 2151. The projection 2148 of lever arm 2144 is shaped to access a channel 2152 formed between a portion of the first member 2112 and the second member 2116 of the activation member 2104. The projection 2148 of the lever arm 2144 is further shaped to releasably engage a retaining ridge 2162 that is positioned within channel 2152. The retaining ridge 2162 includes surfaces complementary to the camming surface 2149 and a locking surface 2151 of the projection 2148. As the activation member 2104 moves to its second position (FIG. 25), the camming surfaces 2149 contact each other and force the lever arm 2144 to rotate counter-clockwise or pivot (as viewed in FIGS. 24 and 25). When the activation member 2104 reaches its second position, the projection 2148 will have fully passed over the retaining ridge 2162 and the locking surface 2151 will become engaged. This engagement is caused by a return force applied to the lever arm 2144 by way of second compression spring 2156 located at a transverse orientation along a return arm 2160 at the opposite end of retaining member 2140. As the activation member 2104 moves linearly in a direction substantially parallel to the direction of motion of the push buttons 12, the lever arm 2144 rotates and the second compression spring 2156 forces the lever arm 2144 to maintain engagement between the camming surfaces 2149. When the locking surfaces 2151 are engaged and the indicator 2170 is in its second position, the second spring 2156 is compressed and provides a force to the lever arm 2144 that biases it into the engaged or locked position (FIG. 25). Once the activation member 2104 is moved to the second position, it reaches a point where the projection 2148 enters a recess 2158, thereby securing the activation member 2104 to the retaining member 2140.

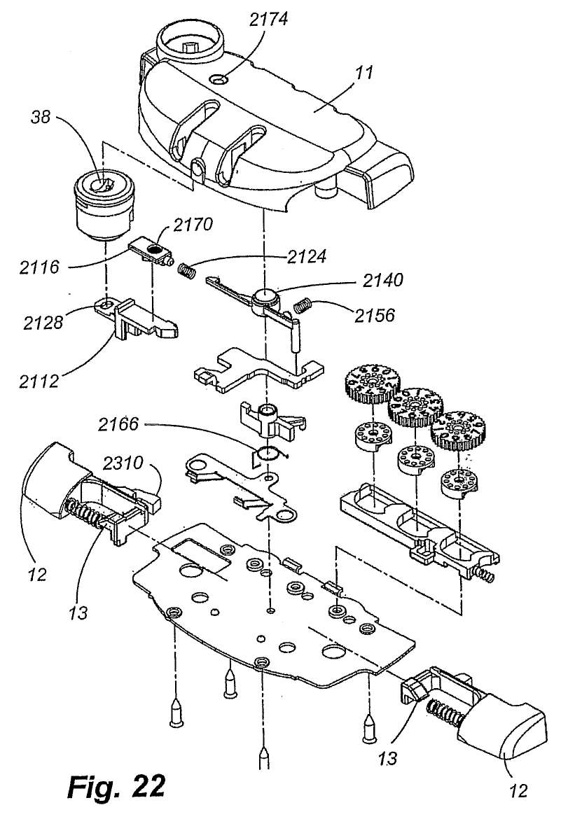

As noted above, when the lever arm 2144 is rotated, the second spring 2156 provides a force against the return arm 2160 of the retaining member 2140 to provide a holding force against the activation member 2104. Thus, the second spring 2156 is oriented to provide a force for retaining the activation member 2104 when in its second position, and to also allow advancement and lateral movement of the activation member 2104 through rotation of lever arm 2144 upon the insertion and rotation of a key K in the key way 38 to rotate the sleeve 31. The first compression spring 2124 similarly provides sufficient force to produce the desired reset movement of the activation member 2104 upon release of the activation member 2104, as discussed below. As best seen in FIG. 22, a counter rotational spring 2166 associated with the retaining member 2140 provides a counter rotational force for holding the retaining member 2140 in its unrotated position, thus maintaining the activation member 2104 is in its first or normal position (FIG. 24).

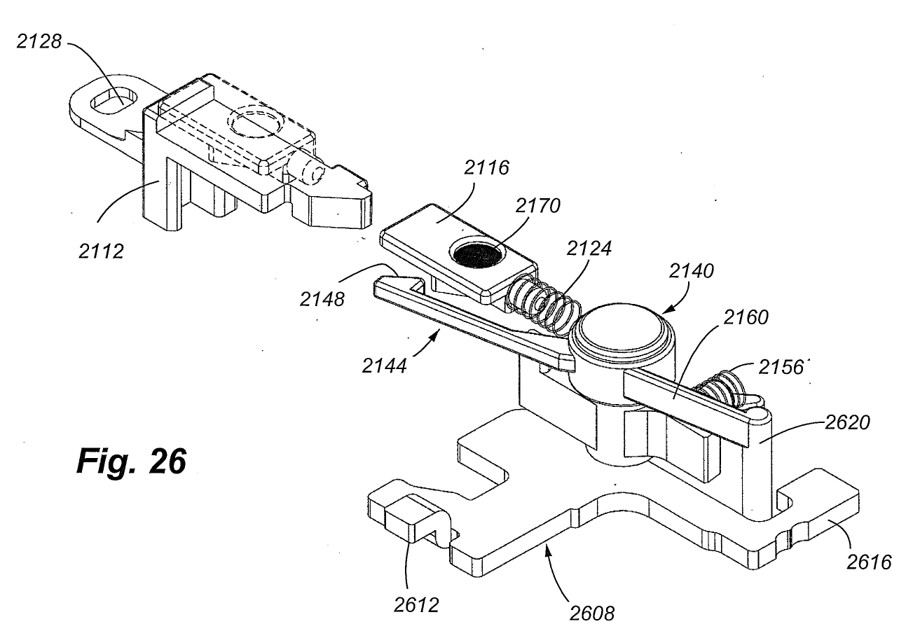

When a suitable key K (e.g., a TSA over-ride key) is inserted into the key way 38 of the key lock or second lock mechanism 30, the sleeve 31 is free to rotate. Upon rotating, the sleeve 31 and protrusion 313 (as seen in FIGS. 5 and 6) move from a first position to a second position. Since the protrusion 313 resides within the slot 2128 of the extension arm 2108, rotation of the protrusion 313 causes linear movement of the extension arm 2108, which moves the activation member 2104 laterally, and in turn causes the lever arm 2144 and retaining member 2140 to rotate counter-clockwise as viewed in FIG. 26. Such action places the activation member 2104 in its second position so that the indicator 2120 is visible, and because the stopping member 14 is co-located with the retaining member 2140, the rotation of the retaining member 2140 also rotates the stopping member 14 to allow the push buttons 12 to be depressed, thereby freeing the tongues 13 from the zipper pulls so that the zipper lock is opened. Accordingly, a TSA agent may thereafter open the zipper and access the contents of the article associated with the zipper lock. When the activation member 2104 is in its second position (FIG. 25), the indicator 2170 is aligned with a viewing aperture 2174 (as shown in FIGS. 21-23) through the housing 11 and is visible from the exterior of the zipper lock. The indicator 2170 preferably includes coloring, visual aspects, or other means for contrasting with the housing 11 and with the remainder of the second member 2116 of the activation member 2104 so that the indicator 2170 is clearly discernible when the activation member 2104 is in a second position and the indicator 2170 is aligned with the viewing aperture 2174.

After the sleeve 31 is rotated back to its original position (from the unlocked or second position back to the original locked or first position), the first member 2112 disengages from the second member 2116, wherein the second member 2116 is retained by the projection 2148 on the distal end 2150 of the lever arm 2144 and the first member 2112 returns to its first position as shown in FIG. 26. Thus, when the lever arm 2144 moves back to its first position, the indicator 2170 and second member 2116 are resettably-secured in the second or revealed position corresponding to indicating that a key K or object has been inserted into the key way 38 and used to open the key lock or second lock mechanism 30.

The activation member 2104 may be reset to its first or normal position by unlocking the combination lock. More particularly, as discussed above for the discussion of FIGS. 2 and 3, use of the correct combination using the dials 21 unlocks the first lock mechanism or combination lock 20, thereby causing the shifting plate 22 to shift from the locking position to the unlocking position, that in turn moves the stopping member 14. As the stopping member 14 moves, the co-located retaining member 2140 also rotates freeing the projection 2148 of the lever arm 2144 from the retaining ridge 2162 of the second member 2116, and the first compression spring 2124 serves to force the second member 2116 linearly from the second position to its first position so that the indicator 2120 is reset.

Referring now to FIG. 26, and in accordance with embodiments of the present invention, the indicator 2170 of the zipper lock may also be reset by using a reset mechanism. The housing 11 of the zipper lock includes an aperture 2604 (as best seen on FIG. 21). Within the housing 11 a reset member 2608 includes a reset button 2612, wherein pressing the reset button 2612 through aperture 2604 causes the reset member 2608 to move transversely within and about the major axis of the zipper lock. The reset member 2608 includes a cross arm 2616 that contacts a post 2620 that is connected to the return arm 2160 of the retaining member 2140. By contacting the post 2620 and rotatably moving the return arm 2160, the lever arm 2144 rotates in a clockwise direction viewed in FIG. 26, and the projection 2148 releases the retaining ridge 2162 of the second member 2116. The first compression spring 2124 then moves the second member 2116 from it second position to its first position, such that the indicator 2170 is no longer visible through the viewing aperture 2174.

In use, the zipper lock provides a simple way for the owner of the zipper lock to monitor whether someone has opened their luggage, baggage or other item using a key. Accordingly, in use, the owner sets the combination by using the plurality of dials 21 to open the combination lock or first lock mechanism 20. The owner may then insert the zipper pulls of an article (e.g., a piece of luggage) into the receptacles of the zipper lock so that the lock tongues 13 engage the holes in the zipper pulls. The owner then rotates one or more of the plurality of dials 21 to lock the zipper lock. At this time, the indicator 2170 is positioned in a first or normal position so that the indicator 2170 is not generally viewable from the exterior of the housing 11 and is otherwise not generally visible through the viewing aperture 2174. Thereafter, if a TSA inspector or other person uses an over-ride key K to unlock the key lock or second lock mechanism 30 of the zipper lock, the rotating sleeve 31 of the second lock mechanism 30 will move the activation member 2104 so that the second member 2116 with the indicator 2170 engages the retaining member 2140. Accordingly, if a TSA inspector or other person uses a key to unlock the key lock or second lock mechanism 30, the indicator 2170 moves such that the indicator 2170 is visible through the viewing aperture 2174. When the article associated with the zipper lock is recovered, the indicator 2170 is viewable through the viewing aperture 2174, thereby alerting the user that the zipper lock has been opened.

As discussed above, embodiments of the present invention may comprise a first lock mechanism 20 being a combination-type of lock and a second lock mechanism 30 being a key-type of lock. Other embodiments may comprise a first lock mechanism 20 being a key-type of lock and a second lock mechanism 30 also being a key-type of lock. For example, the first lock mechanism 20 may be a key lock where a specific key allows a user to open the lock, and the second lock mechanism 30 is configured to accept a TSA over-ride key. Other embodiments may comprise a lock having a single key-type of lock with one key cylinder where a master key (such as a TSA over-ride) is capable of opening the lock and where a slave key or user specific key is also capable of opening the same key lock using the same key cylinder. Other embodiments of the present invention may incorporate two combination-type locks with no key locks. Alternatively, a single combination type of lock may be used for securing the zipper-pulls. Still other means may be used to open locks used in association with the present invention, where such other locking means may include key pads, voice activated locks, bio-metric activated mechanisms such as fingerprint activated locks, and radio frequency operated locks.

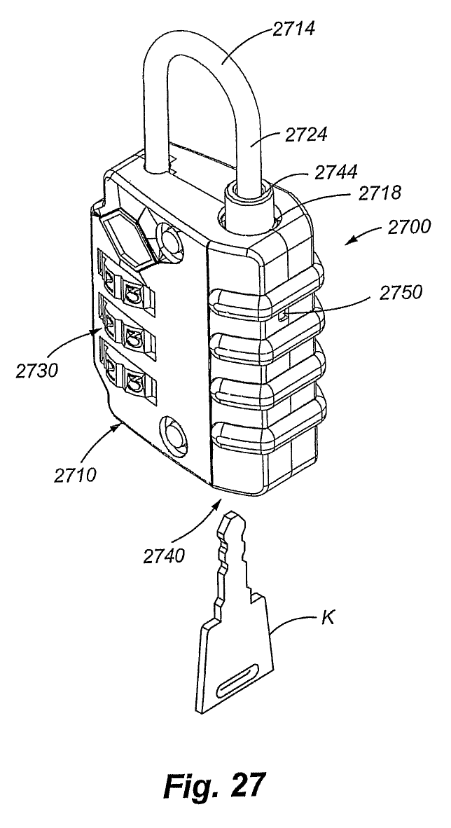

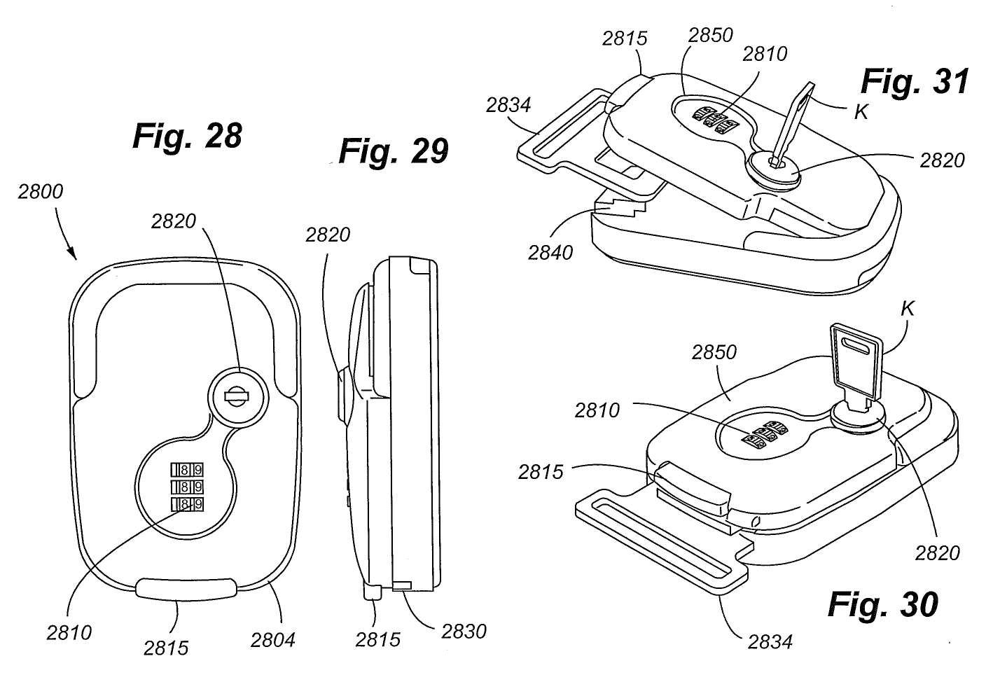

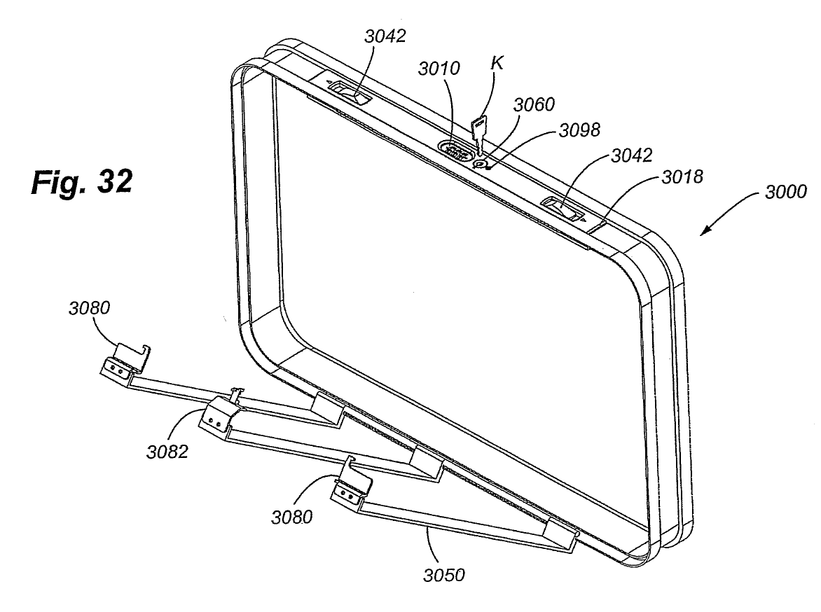

While particular embodiments of the present invention have been described in some detail, it should be understood that other related embodiments are intended to be within the scope of the present invention. For example, the present invention may also be used for securing items other than luggage and may be attached to a portion of an article to be secured or some other structure other than a pair of zipper pulls, such as with the shackle of a padlock engaging overlapping apertures on a pair of locking plates associated with a crate or other sealable item. The advantageous operation of the latching member or lock tongue 13 described above in reference to FIGS. 19A-19F, which allows the key to be removed from the lock mechanism and allows the lock to be relocked by simply reinserting the zipper pull Z into the lock, may be incorporated with various other lock body types. It is intended that various other articles may be secured in conceptually the same way by an engaging member and include structures that are complementary to the engaging member such as latches, rings, chains, cable loops, straps, container lids, the lock tongues of the zipper lock or shackle of the padlock described above, or any other type of article which may be engaged with an engaging member. It is to be expressly understood that other types of engaging members also may be incorporated with the embodiments described herein, such as bolts, clips, hooks, blades, tongues, or other style of engaging member used to secure an article to a lock mechanism. Other specific lock types contemplated for use with the concepts described herein include, but are not limited to a padlock (as shown in FIG. 27); a strap lock (as shown in FIGS. 28-31); and/or a lock integrated into a piece of hard-sided luggage (as shown in FIGS. 32-45), as described in greater detail below. Such modifications, alternate uses and/or adaptations are within the scope of the present invention, including those that are well within the knowledge of those of ordinary skill in this art, regardless of whether such structures and/or uses are conventional or developed in the future.

Referring now to FIG. 27, a padlock type lock is shown. The padlock 2700 includes a lock body 2710, a shackle 2714 for securing an item, a collar 2718 for receiving a first end 2724 of the shackle 2714, and a first lock mechanism 2730 and a second lock mechanism 2740. The collar 2718 may rotate, slide laterally relative to the first end of the shackle 2714, or move downwardly relative to the first end 2724 of the shackle 2714 to release the shackle 2714 and unlock the padlock 2700. In FIG. 27 the first lock mechanism 2730 is a combination lock and the second lock mechanism 2740 is a key lock. Like the zipper lock embodiment described above, the padlock 2700 shown in FIG. 27 may further comprise means for relocking the first end 2724 of the shackle 2714 in the collar 2718 after a key K has been used to open the second lock mechanism 2740, but with the key removed from the second lock mechanism. This may be accomplished, for example, by use of a position fixing block similar to that described above in reference to the zipper lock embodiment, or by the use of an equivalent structure for retaining and then releasing a locking member such that when the free end 2724 of the shackle 2714 is repositioned in the collar 2718, the locking member secures the shackle 2714 and the free end may not be removed from the collar 2718 without unlocking one of the first 2730 and second 2740 locking mechanisms. The act of manually moving the collar 2718 to its original locking position may cause reactivation of the padlock 2700. For example, if opening of the second locking mechanism 2740 causes the locking member to slide downwardly out of the body 2710 of the lock, the act of pushing it back into place, analogous to a lock on a horizontal filing cabinet, can achieve relocking of the padlock 2700 without use of the key K.

Referring now to FIGS. 28-31, a strap lock type lock is shown. The strap lock 2800 includes a lock body 2804, a slot 2830 for receiving a buckle 2834, a first lock mechanism 2810, and a second lock mechanism 2820. As shown in FIG. 30, the first locking mechanism 2810 is a combination operated lock and the second lock mechanism 2820 is a key lock for receiving a key K. A button 2815 is associated with the combination lock 2810 such that the buckle 2834 may be released from the locking mechanism 2840 by entering the correct combination and without opening and removing the face plate 2850 from the lock body 2804. The second or key lock 2820 operates by opening and releasing the face plate 2850. The strap lock 2800 may further comprise means for relocking the buckle 2834 in the slot 2830 after a key K has been used to open the second lock mechanism 2820, but with the key K removed from the key lock 2820. This may be accomplished, for example, by use of a position fixing block (not shown) similar to that described above in reference to the zipper lock embodiment, or by the use of an equivalent structure for retaining a locking member. Thus, the TSA agent may use the key K to release the face plate 2850, remove the key K from the key lock 2820, inspect the luggage and relock the strap lock 2800 by pressing the face plate 2850 back into its original position without use of the key K. Alternatively, operation of the two locks may be switched, such that the combination lock 2810 opens the face plate 2850 and the key K activates the button 2815. In this scenario, when the key K is used to activate the button 2815 and release the strap, the buckle 2834 may be slid back into slot 2830 in an analogous fashion to that of a seat belt. Thus, the strap lock 2800 of FIGS. 28-31 may once again be locked, even though the TSA agent has removed the override key.

Referring now to FIGS. 32-45, a hard luggage lock is shown. The hard luggage lock 3000 comprises a first locking mechanism 3010, which is shown as a combination locking mechanism, and a second locking mechanism 3060, which in FIGS. 32-45 is a key lock. In accordance with embodiments of the present invention, a hard luggage lock 3000 is provided for enabling the locking arms 3050 to be separated from the lock housing 3018 after the key K has been removed from the second lock mechanism 3060 without first reinserting the key K into the keyhole 3064 and turning the key K.

Referring now to FIG. 32, the lock includes a housing 3018, a first lock mechanism 3010 and a second lock mechanism 3060. In FIG. 32, the first lock mechanism 3010 is a combination lock mechanism, while the second lock mechanism 3060 is a key lock mechanism.

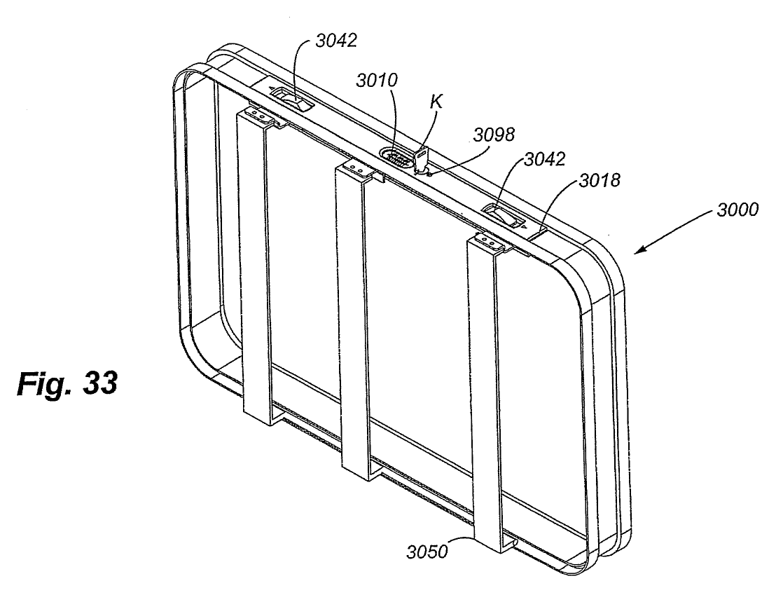

The housing 3018 includes locking arms 3050 with locking plates 3080, 3082 which are received when the luggage lock 3000 is in a locked configuration (as shown in FIG. 33) by openings (not shown in FIG. 32 or FIG. 33) within the housing 3018. When the luggage lock 3000 is in an unlocked configuration, the release buttons 3042 can be depressed by a force, such as by a user's fingers, to release the locking plates 3080, 3082 from the lock housing 2018, as described in greater detail below.

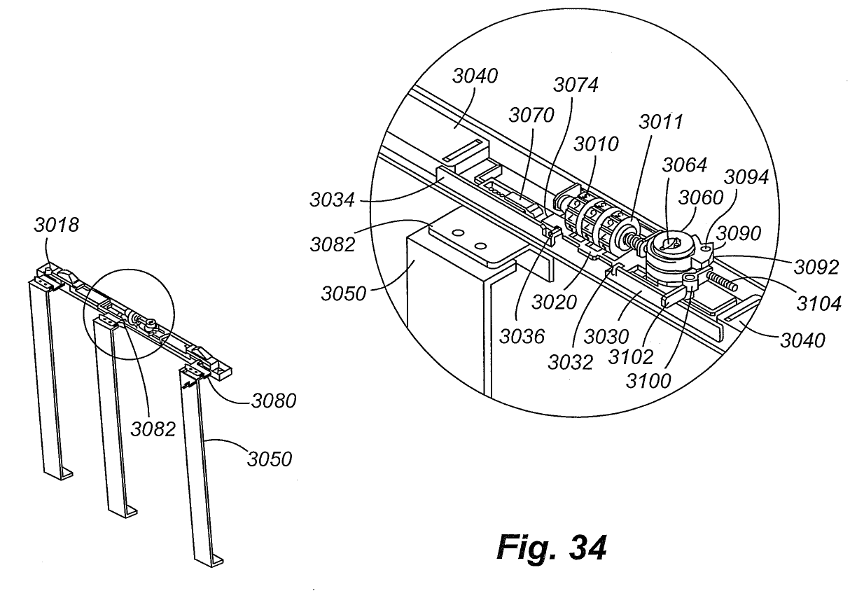

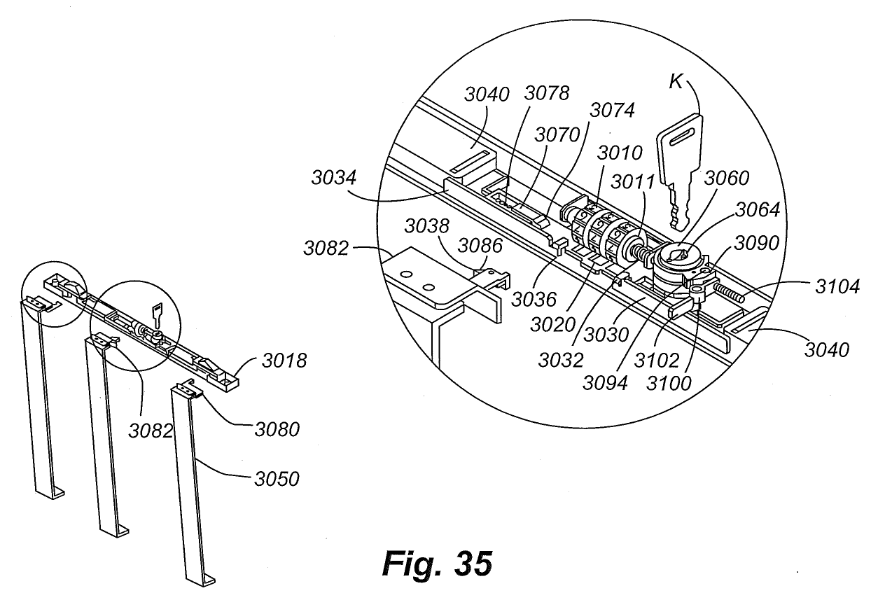

Referring now to FIGS. 34-35, shifting members 3040 located within the housing 3018 are coupled, respectively, to linking members 3030, 3034 and are moveable in a direction substantially parallel to the longitudinal axis of the housing 3018 in the same fashion as the shifting members 3040 upon application of force to the release buttons 3042. The linking members 3030, 3034 have extensions 3032, 3036 which project inwardly, and which are received by and engage with slots 3024, 3028 (shown in FIG. 37) located on the shifting plate 3020 when the shifting plate 3020 is in the locking position. The shifting plate 3020 holds the linking members 3030, 3034 and the shifting members 3040 by retaining the extensions 3032, 3036 within the slots 3024, 3028 and preventing longitudinal movement of the shifting members 3040. This retention prevents the locking arms 3050 from being released and maintains the lock in its locking position.

Embodiments of the present invention may include the use of a retaining clip 3070 which moves from a first position (as shown in FIG. 34) to a second position (as shown in FIG. 35) within the housing 3018 of the lock. This allows the shifting plate 3020 to remain in an unlocked position after the key K (as shown in FIG. 35) has been used to unlock the second lock mechanism 3060 and removed from the keyhole 3064, and will be understood from the following drawings and detailed description.

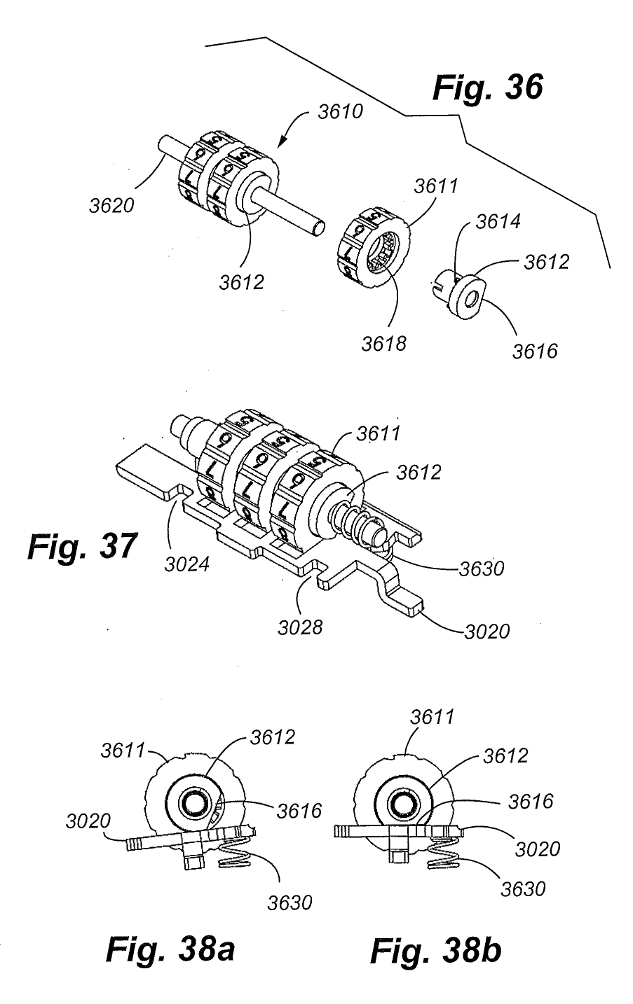

Referring now to FIGS. 36-38, the combination lock mechanism in an embodiment of the invention is shown. The first lock mechanism 3610 is a combination lock mechanism including a plurality of dials 3611 positioned in the housing 3018. The plurality of dials 3611 are centered and positioned on a cylindrical member 3620, and are coupled respectively to camming members 3612. Each camming member 3612 is held in place by tongues 3614 positioned circumferentially about the camming member 3612, the tongues 3614 being inserted in to grooves 3618 located on an interior portion of each of the plurality of dials 3611. The camming members 3612 also comprise a first surface 3616 which varies from the generally cylindrical shape of each camming member 3612 in order to communicate with the shifting plate 3020 as described in the following paragraphs.

As shown in FIGS. 37-38, a shifting plate 3020 can be shifted to a locked position (as shown in FIG. 38a) or an unlocked position (as shown in FIG. 38b) by appropriately setting the plurality of dials 3611. When the plurality of dials 3611 are each in the correct combination position, their respective camming members 3612 are aligned so the first surfaces 3616 of each camming member 3612 contact the shifting plate 3020, as shown in FIG. 38b. Thus, the shifting plate 3020 and the first lock mechanism 3610 operate interactively, and once the plurality of dials 3611 are in the correct position the orientation of each of the camming members 3612 causes the shifting plate 3020 to move in a generally upwardly direction (as shown in FIG. 38b), which will correspondingly allow movement of shifting members 3040 and subsequently release the constraint on the locking arms 3050 (as described in greater detail below). When the plurality of dials 3611 are in a position other than the correct combination setting, the shifting plate 3020 will be in a locked position (as shown in FIG. 38a) due to the rotation of the camming members 3612.

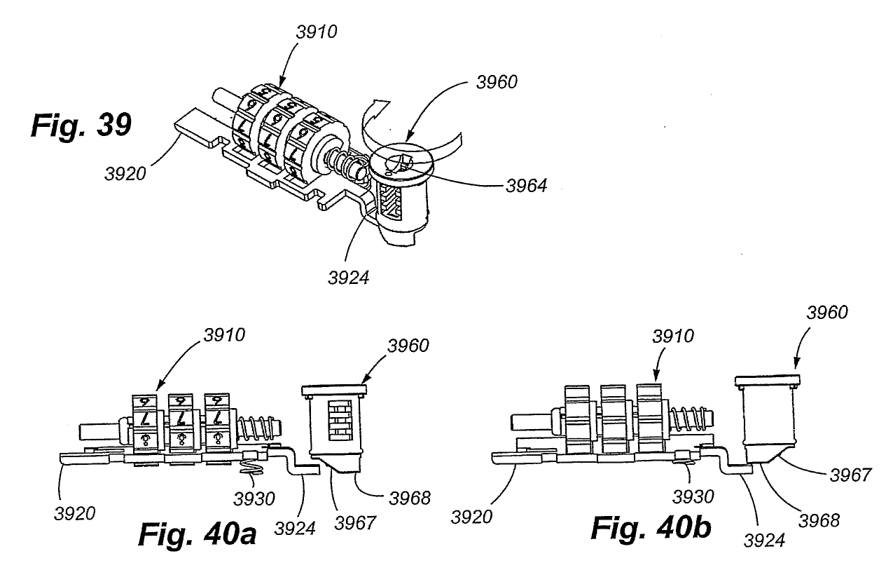

In accordance with at least one embodiment of the present invention, the luggage lock 3000 may include a second lock mechanism 3060, which may be a key lock mechanism. Referring now to FIGS. 39-40, a key lock mechanism 3960 allows the luggage lock 3600 to be unlocked in an alternative way. The key lock mechanism 3960 is comprised of a key way 3964, a first sloped surface 3967 and a second horizontal surface 3968, as shown in FIG. 40a. As the key lock mechanism 3960 is unlocked (by inserting an authorized key in to the key way 3964 and rotating in the direction of the arrow shown in FIG. 39, the first sloped surface 3967 and second horizontal surface 3968 are also rotated, causing action with the shifting plate 3920. The shifting plate 3920 is biased in a generally transverse direction by a biasing member 3930, and includes an extension 3924, which is located adjacent to the key lock mechanism 3960 and operatively associated with the key lock mechanism 3960. As the key is turned in the key way 3964 to unlock the key lock 3960, the second horizontal surface 3968 rotates towards the extension 3924 and contacts the extension 3924, forcing the extension 3924 and thereby the shifting plate 3920 to move in a generally downwardly direction (as shown in FIG. 40b) and compressing the biasing member 3930. Once the key lock 3960 is relocked, the key lock mechanism 3960 rotates so that the second horizontal surface rotates away from the extension 3924, causing the biasing member 3930 to bias the shifting plate 3920 and move it in a generally upwardly direction to a locked position.

Referring back to FIGS. 34-35, the second lock mechanism 3060 further includes a keyhole 3064 for allowing a key “K” to be inserted and rotated such that the shifting plate 3020 is moved between an unlocked (as shown in FIG. 35) and a locked position (as shown in FIG. 34). Without the key “K” being inserted into the keyhole 3064 and rotated to unlock the second lock mechanism 3060, the second lock mechanism may not move relative to housing 3018. Once the key “K” is inserted into the keyhole 3064 and rotated, the second lock mechanism 3060 is free to rotate relative to the housing 3018. As key “K” is inserted into the keyhole 3064 and rotated to unlock the second lock mechanism 3060, the rotation causes the shifting plate 3020 to move in a generally downward direction to an unlocked position (as shown in FIG. 35). In this unlocked position, the extensions 3032, 3036 are no longer engaged with the slots 3024, 3028 of the shifting plate 3020. The movement of the shifting plate 3020 to this unlocked position thus allows the shifting members 3040 to be moved longitudinally (by contacting and moving the release buttons 3042 longitudinally) and allow the lock to be unlocked.

Similarly for the first lock mechanism 3010, when the plurality of dials 3021 are set to the correct combination, the shifting plate 3020 is shifted in a generally upward direction (as shown in FIG. 38b) to an unlocked position, and the extensions 3032, 3036 are no longer retained by the shifting plate 3020. The movement of the shifting plate 3020 to this unlocked position thus allows the shifting members 3040 to be moved longitudinally and allows the luggage lock 3000 to be unlocked. Therefore, for some embodiments of the present invention, the unlocking action of the lock can be performed by utilizing either the combination lock mechanism 3010 or the key lock mechanism 3060.

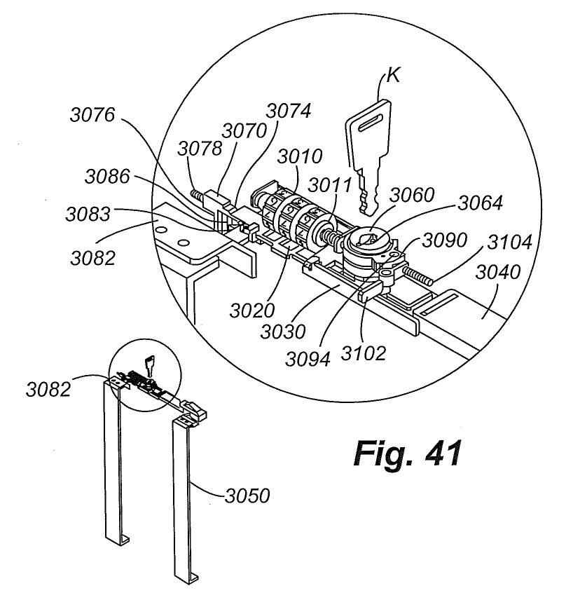

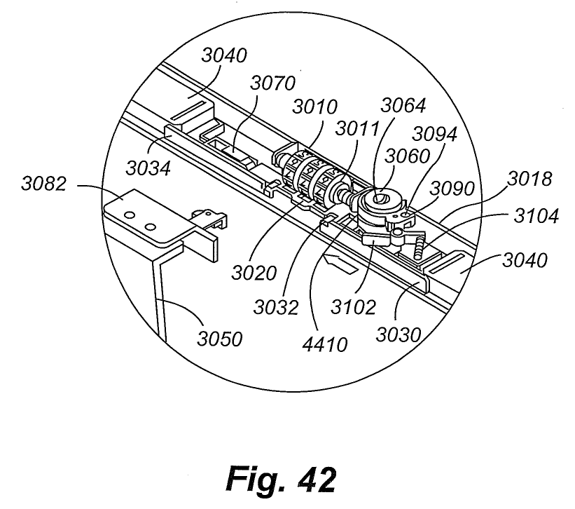

Referring now to FIGS. 41-42, and in accordance with embodiments of the present invention, a lock is provided for enabling the locking plates 3080, 3082 to be relocked after the key K has been removed from the second lock mechanism 3060 without first reinserting the key K into the keyhole 3064 and unlocking the second lock mechanism 3060. More particularly, embodiments of the present invention may include a way of allowing the shifting plate 3020 to remain in an unlocked position after the key K has been used to unlock the second lock mechanism 3060 and removed from the keyhole 3064. The retaining clip 3070 is biased by a biasing member 3078, as shown in FIG. 41, and further comprises a sloped surface 3074 which contacts the shifting plate 3020, as the shifting plate 3020 moves from its normal position (as shown in FIG. 34) to an unlocked position (as shown in FIG. 35). The retaining clip 3070 is displaced as a result of contact between the shifting plate 3020 and the sloped surface 3074 of the retaining clip 3070, and the biasing member 3078 compresses and exerts a returning force against the retaining clip 3070. Once the shifting plate 3020 has moved to the unlocked position (as shown in FIG. 35), the sloped surface 3074 of the retaining clip 3070 is no longer in contact with the shifting plate 3020, and the biasing member 3078 forces the retaining clip 3070 to override the shifting plate 3020, thereby retaining and holding the shifting plate 3020 in the unlocked position (as shown in FIG. 35). This allows the shifting plate 3020 to remain in an unlocked position after the key K (as shown in FIG. 35) has been used to unlock the second lock mechanism 3060 and removed from the keyhole 3064.

Referring now to FIGS. 41-45, the retaining clip 3070 may be reset allowing the shifting plate 3020 to return to a locked position. The retaining clip 3070 may be moved back against the biasing member 3078, and thereby release the shifting plate 3020 in the following manner. First, the locking plates 3080, 3082 are inserted in to the openings 3046 to secure the locking plates 3080, 3082 and thereby lock the hard luggage lock 3000. One of the locking plates 3082 is modified to be positioned below a bottom surface of the lock housing 3018 and adjacent to the location of the retaining clip 3070 when the locking plate 3082 is in a closed or locked position (as shown in FIG. 41). Locking plate 3082 contacts a lower portion 3076 of the retaining clip 3070 upon insertion of the locking arm 3082 in to the opening 3046 of the lock body 3018. The lower portion 3076 of the retaining clip 3070 contacts a sloped surface 3086 of the retaining clip 3070 as the locking arm 3082 is received within the lock housing 3018. As the locking arm 3082 is moved further into the lock housing 3018, the movement of the locking arm 3082 contacts the sloped surface 3086 on the lower portion 3076 of the retaining clip 3070, causing the retaining clip 3070 to move to its first position (as shown in FIG. 34). This movement further causes the shifting plate 3020 to become disengaged from the retaining clip 3070, thereby allowing the shifting plate 3020 to move back to its locked position (as shown in FIG. 34) and relock the lock.

This contact between the shifting plate 3020, retaining clip 3070 and locking arm 3082 allows the hard luggage lock 3000 to be relocked without requiring the insertion of a key in the second lock mechanism 3060 or key lock. For example, a TSA agent may use an over-ride key to open the second lock 3060. When the second lock 3060 is unlocked, the release buttons 3042 can be depressed to move the linking members 3030, 3034 and allow the locking plates 3080, 3082 to be removed from the openings 3046. The shifting plate 3020 moves to its unlocked position and is retained by the retaining clip 3070. The TSA agent may now remove the key and allow the article or piece of luggage associated with the luggage lock to be opened by, for example, another TSA agent. Furthermore, the lock may be relocked by a TSA agent without first inserting the over-ride key in to the second lock 3060 to unlock the lock. Thus, the hard luggage lock 3000 may be opened and once again become locked, even though the TSA agent may have already removed the over-ride key.

The lock types described above (padlock, strap lock and hard luggage lock) in reference to FIGS. 27-45 may also incorporate the use of a mechanism for indicating whether a key K or other object has been inserted into the key lock. Referring to FIG. 27, an indicator 2744 may be coupled to the collar 2718, or be the collar 2718, and become exposed by moving to a revealed position outside the lock body 2710 and adjacent the shackle 2714. Similar to the zipper lock described above, the padlock 2700 may further comprise a reset mechanism as described in reference to FIG. 26 above. Referring again to FIG. 27, a reset mechanism 2750 of the padlock 2700 lock embodiment may be accessible from the exterior of the housing 2710, so that the indicator 2744 may be reset without unlocking the padlock 2700.

Referring back to FIGS. 28-31, an indicator (not shown) may be incorporated in the strap lock 2800 for indicating that an object or a key has been inserted into the second lock mechanism 2820. For example, the indicator may be viewable through an aperture in the face plate 2850 or in another location on the exterior of the lock body 2804, and the indicator moveable from a first generally hidden position to a second revealed position via the aperture. The strap lock 2800 may further comprise resetting means for resetting the indicator as described in reference to the zipper lock above.

Referring again now to FIGS. 32-45, and in accordance with at least one embodiment of the present invention, a luggage lock is shown with a mechanism for indicating whether a key K or other object has been inserted into the keyway of the key lock mechanism either in an authorized fashion, such as by a TSA agent, or in an unauthorized fashion, such as by a person seeking to gain unauthorized access to the contents of the luggage. Similar to the previously described luggage locks, the luggage lock of the present embodiment includes a housing 3018, a pair of shifting members 3040, two release buttons 3042, a first lock mechanism 3010, a second lock mechanism 3060, and an activation member 3090 that resides within the housing 3018, which includes an indicator 3094 that is operatively associated with the second lock mechanism 3060.

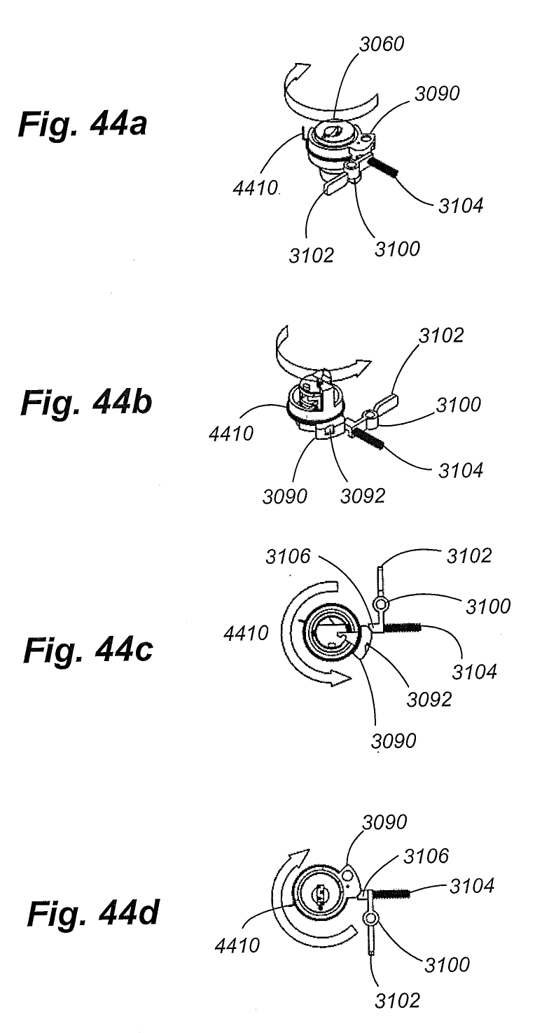

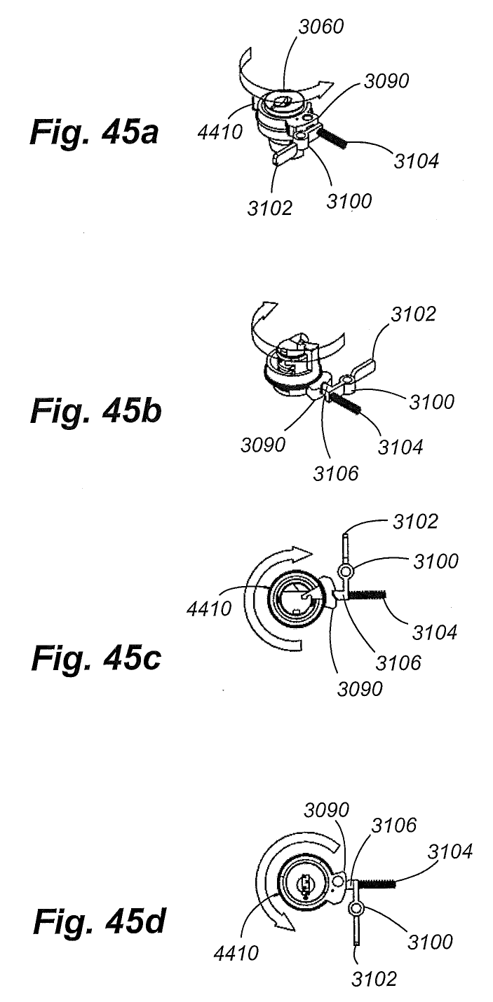

As best seen in FIGS. 34 and 42, the activation member 3090 is coupled to the sleeve of the second lock mechanism 3060, and further comprises an indicator 3094. When the activation member 3090 is positioned in a first or normal position, the indicator 3094 would represent that the key lock or second lock mechanism 3060 has not been used to open the luggage lock 3000. However, the indicator 3094 may become positioned in a second position for indicating that the key lock or second lock mechanism 3060 has been used to open the luggage lock 3000 or that someone has attempted to open the second lock mechanism. The activation member 3090 includes a slot or receptacle 3092 in the portion of the activation member 3090 away from the sleeve 3061. When a key K is inserted into the keyhole 3064 and rotated, the sleeve 3061 moves the activation member 3090 rotationally in a clockwise direction to place the indicator 3094 in its second position. As shown in FIGS. 41 and 42, the activation member 3090 is held in its second position by contact with a resetting piece 3100. The resetting piece 3100 is comprised of a lever arm 3102, and also includes a biasing member, such as a compression spring 3104, located adjacent the resetting piece 3100 and biasing one end of the resetting piece 3100 opposite the lever arm 3102. The resetting piece 3100 pivots about a central portion. The compression spring 3104 compresses as the activation member 3090 contacts the resetting piece 3100 as the activation member 3090 moves rotationally from the first position (as shown in FIGS. 44a-44d) to the second position (as shown in FIGS. 45a-45d).

When in the second position (as shown in FIGS. 45a-45d), the activation member 3090 is held in place by a retaining projection 3106 which extends outwardly from the resetting piece 3100 opposite the compression spring 3104, and engages with the receptacle 3092 once the activation member 3090 rotates to its second position. The force provided by the compression spring 3104 biases the resetting piece 3100 and creates a positive holding force preventing the activation member 3090 from returning to its first position upon unlocking the lock and removal of the key K from the keyhole 3064 after the key lock is rotated back and maintains this positive holding force. The activation member 3090 is closely coupled to the sleeve of the key lock 3060 to allow for movement with the sleeve once a key K is inserted into the keyhole 3064 and rotated to unlock the key lock 3060. A rotational spring 4410 biases the activation member 3090 in the direction of the arrows shown in FIGS. 45a-45d, thereby allowing the activation member 3090 to return to its first position after the retaining projection is disengaged from the activation member 3090 as described in greater detail below.

In operation, when an authorized key K (e.g., a TSA over-ride key) is inserted into the key hole 3064 of the second lock mechanism 3060, the sleeve is free to rotate. Upon rotation of the key in the key hole, the sleeve and activation member 3090 (as seen in FIGS. 44a-44d and 45a-45d) moves from a first position (FIG. 44a) to a second position (FIG. 45a). Since the activation member 3090 is positioned proximate to the resetting piece 3100, rotation of the activation member 3090 causes the receptacle 3092 to contact the resetting piece 3100, and in turn causes the compression spring 3104 to compress. As the activation member 3090 rotates to the second position, the projection aligns with the receptacle 3092 and is received by the receptacle 3092 (as shown in FIG. 45a). The compression spring 3104 provides force to hold the projection in the receptacle 3092, and thereby holds the activation member 3090 in the second position even after the sleeve returns to the first position. In the second position, the indicator 3094 has been rotated within the housing 3018 so that it is visible through an aperture (as shown in FIG. 32 as 3098) in the top portion of the lock housing 3018. The indicator 3094 preferably includes coloring, visual aspects, or other means for contrasting with the housing 3018 and with the remainder of the activation member 3090 so that the indicator 3094 is clearly discernible when the activation member 3090 is in a second position and the indicator 3094 is aligned with the viewing aperture 3098.

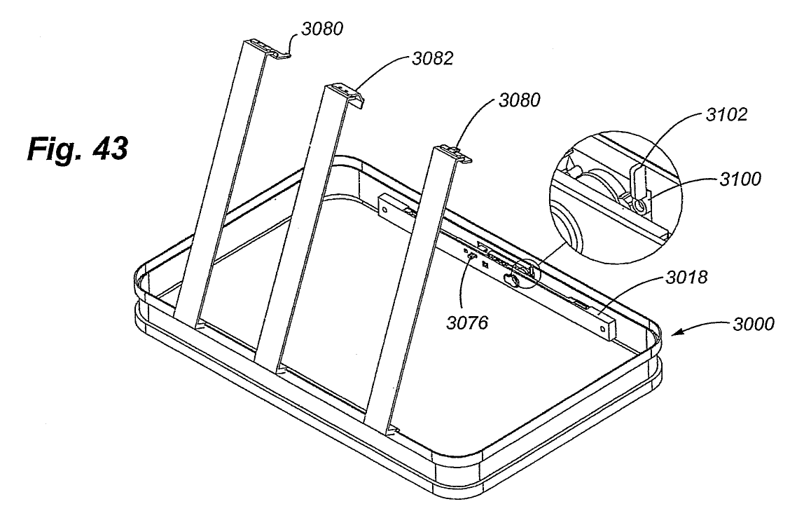

Referring now to FIGS. 41-45, and in accordance with embodiments of the present invention, the indicator 3094 and activation member 3090 of the luggage lock 3000 may also be reset by using the resetting piece 3100. In the second position, the activation member 3090 is held in place by the projection 3106 (shown in FIGS. 44 and 45) being retained in the receptacle by the force exerted by the compression spring 3104. The resetting piece 3100 is fixed within the housing 3018 by its central portion, but may rotate or pivot about the central portion, thus providing the means for receiving the projection 3106 in to the receptacle 3092 upon rotation of the activation member 3090. However, the lever arm 3102 of the resetting piece 3100, which is opposite the portion of the resetting piece 3100 comprising the projection 3106, extends outside of the housing 3018 of the luggage lock 3000 (as shown in FIG. 43), and may be moved by a user to rotate the resetting piece 3100 as shown by the direction of the arrow in FIG. 42. The rotational movement of the lever arm 3102 in this direction causes the compression spring 3104 to compress and the projection 3106 to be removed from the receptacle 3092 and disengage the activation member 3090. A rotational spring 4410 (as shown in FIGS. 44-45) coupled to the activation member 3090 provides sufficient force to bias the activation member 3090 back to its first position (FIG. 44a).

In use, the luggage lock 3000 according to this embodiment provides a simple way for the owner to monitor whether someone has opened or attempted to open their luggage using a key or similar tool. Accordingly, in use, the owner sets the combination by using the plurality of dials 3011 to open the combination lock or first lock 3010. The owner may then close the article of luggage in the customary fashion by engaging the locking plates 3080, 3082 in their corresponding openings 3046. The owner then rotates one or more of the plurality of dials 3011 to lock the luggage lock. At this time, the indicator 3094 is positioned in a first or normal position so that the indicator 3094 is generally not viewable from the exterior of the housing 3018 and is otherwise not visible through the viewing aperture 3098. Thereafter, if a TSA inspector or other person uses an over-ride key K to unlock the key lock or second lock mechanism 3060 of the luggage lock, the rotating sleeve of the second lock 3060 will move the activation member 3090 so that the projection 3106 on the resetting piece 3100 engages the receptacle 3092 on the activation member 3090, holding the activation member 3090 and the indicator 3094 in the second position. Accordingly, if a TSA inspector or other person uses a key to unlock the key lock or second lock mechanism 3060, the indicator 3092 moves such that the indicator 3092 is visible through the viewing aperture 3098, informing the owner that the luggage lock has been unlocked. When the article of luggage is recovered by the owner, the indicator 3092 is viewable through the viewing aperture 3098. The owner may reset the activation member 3090 and move the indicator 3092 to its first position by rotating the resetting piece 3100 by rotating the lever arm 3102.

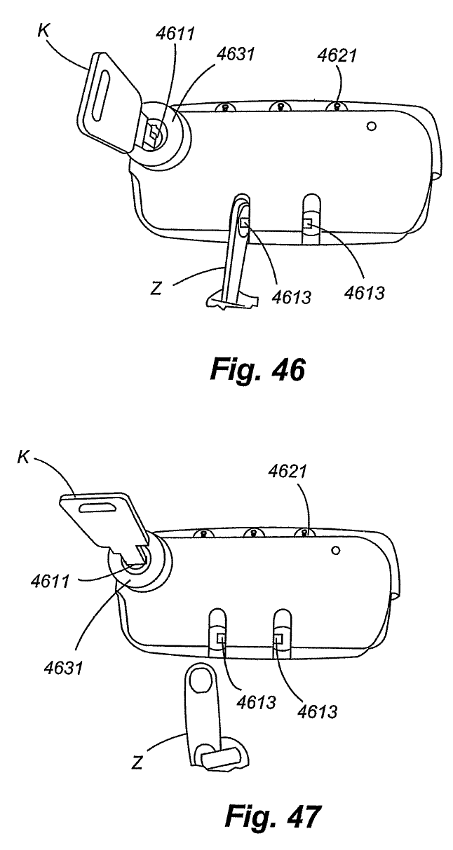

Referring now to FIGS. 46-50, and in accordance with at least one embodiment of the present invention, a lock may comprise a mechanism for retaining the key within the key lock cylinder until the key has been positioned in a locked position. A lock in accordance with this embodiment prevents a TSA agent or other authorized individual to remove the key from the key lock mechanism when the key has been inserted in the key lock mechanism and positioned in an unlocked state. This prevents the authorized person from removing the key when the lock is in an unlocked position and prevents the false appearance that the lock is in fact locked. For example, in some locks if the key is removable from the lock body with the key lock in an unlocked state, the latch or engaging member may still engage or latch an article or component of the luggage but the lock may nonetheless be active and openable. This embodiment precludes this from happening.

Referring to FIG. 46, a lock comprises a first lock mechanism (here, a combination lock mechanism) including a plurality of dials 4621, a second lock mechanism 4631 including a keyhole 4611 for inserting a key K, and lock tongues 4613 for engaging an article of luggage, such as a zipper pull Z. For locks according to this embodiment, the lock can be locked by the first lock mechanism, but can be unlocked by either setting the plurality of dials 4621 to the correct positions or by the second lock mechanism 4631. As described in greater detail above in relation to the lock of FIGS. 1-3, the second lock mechanism 4631 according to this embodiment comprises a sleeve and a linking member (not shown in FIGS. 46-50) in relation with each other (as described in relation to FIGS. 5 and 6 above). The second lock mechanism 4631 further includes a keyhole 4611 for allowing a key “K” to be inserted and rotated such that the linking member (not shown) is shifted to lock and unlock the second lock mechanism 4631. When the key “K” is not inserted into the keyhole 4611, the second lock mechanism 4631 is not allowed to rotate or otherwise move relative to the lock housing. Once the key “K” is inserted into the keyhole 4611, the second lock mechanism 4631 is free to move relative to the lock housing. Since the technology of combination lock mechanism has been explained above, further details are not repeated here.

In operation, the lock according to this embodiment prevents the key K from being removed when the second lock mechanism 4631 has been positioned in the unlocked position. Referring again to FIG. 46, a lock in a locked state is shown with the lock tongues 4613 engaging a zipper pull Z. An authorized key K may be inserted in the keyhole 4611 of the second lock mechanism 4631 to unlock the lock. The key K, once inserted fully in to the keyhole 4611, may be positioned in an unlocked position (as shown in FIG. 47) and cause the linking member (not shown) to shift thereby releasing the constraint on the lock tongues 4613 and allowing the zipper pull Z to become disengaged from the lock tongues 4613. However, according to this embodiment, the key K may not be removed from the keyhole 4611 when it is positioned in this unlocked position (as shown in FIG. 47).

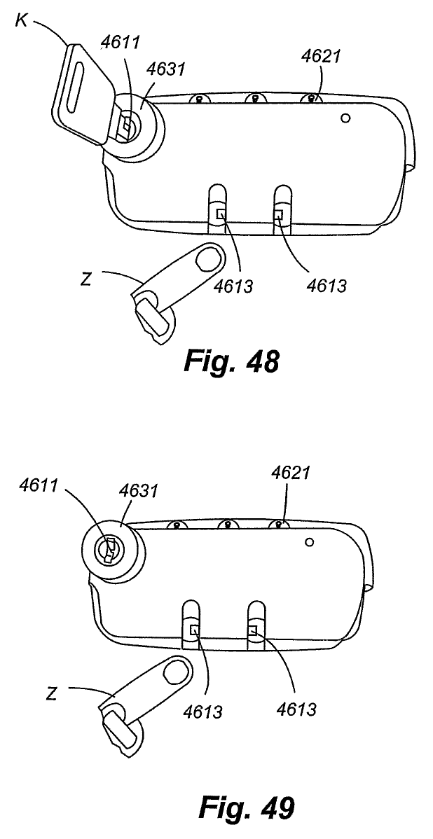

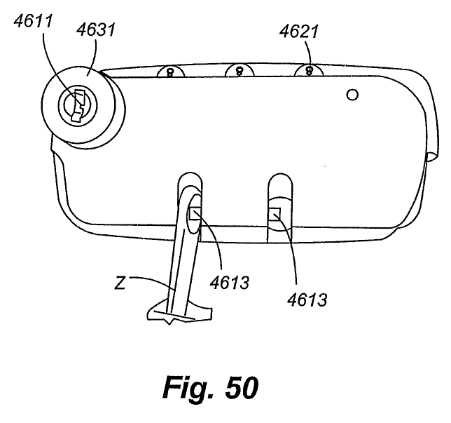

In order to remove the key K from the keyhole 4611, the key K must first be positioned back in the locked position as shown in FIG. 48. Thus, by completing the process of inserting an authorized key K in the keyhole 4611 (FIG. 46), rotating the key K to unlock the second lock mechanism 4631 (FIG. 47), removing the zipper pull Z from the lock tongues 4613 (FIG. 47), and then positioning the key K back to the locked position (FIG. 48), an authorized user such as a TSA agent is prevented from removing the key K and allowing the lock to remain unlocked after inspection. Furthermore, as described above in relation to the lock of FIGS. 41-42, the lock in this embodiment allows the zipper pull Z to be reengaged with the lock tongues 4613 after the inspection has been completed (as shown in FIG. 50), thus allowing one to secure the lock tongue 4613 in a locked position, and relock the lock without first inserting the authorized key K or otherwise using the key. This functionally prevents the first lock mechanism from becoming unusable or defeated due to the unlocking of the second lock mechanism 4631. It is to be expressly understood that locks other than the type of lock shown in FIGS. 46-50 may be used in conjunction with this concept, such as a strap lock, a hard luggage lock, or a padlock, so long as they include at least one key lock mechanism for unlocking and relocking the lock.

The key retaining function as described above in relation to FIGS. 46-50 may be accomplished in a variety of ways. Referring again to FIG. 4, a partially exploded view of the second lock mechanism is shown. The second lock mechanism of FIG. 4 is comparable to the second lock mechanism according to the embodiment described in relation to FIGS. 46-50. As shown in FIG. 4, the second lock mechanism comprises a sleeve 31, which includes a plurality of discs 312 which protrude out of the sleeve 31 in normal condition. The lock housing 11 comprises an opening for receiving the sleeve 31, and includes a cavity 111 having a groove 112 for receiving the discs 312. The sleeve 31 is not free to rotate once the discs 312 are inserted into the groove 112. Once the key “K” is inserted into the keyhole 311, the discs 312 are drawn back or retracted, and the sleeve 31 is free to rotate relative to the lock housing. According to the lock described in FIGS. 46-50, at least one of the discs 312 may be drawn back or retracted so as to engage with at least one surface of the key K such that the teeth of the key K are retained within the keyhole 311, thus preventing the key from being removed from the keyhole 311 while the discs 312 are drawn back or retracted. Thus the contact between at least one of the discs 312 and the surface of the key K prevents the key K from being removed from the keyhole 311 until the key is rotated back to the unlocked position and the discs 312 are free to move back into the groove 112 and disengage the surface of the key K.

Alternatively, the lock according to this embodiment may further comprise a second set of discs and a second groove (not shown in FIG. 4) in addition to the discs 312 and groove 112 shown in FIG. 4, which may similarly be drawn back or retracted so as to engage the surface of the key K when it is inserted in the keyhole 311 and rotated to the unlocked position. Thus the lock according to this alternative embodiment may provide additional means for engaging the key K and preventing the key K from being removed from the keyhole 311 when it is in an unlocked state. In either this alternate embodiment or the previous embodiment, the key lock mechanism includes a retaining function for preventing the key in the locking mechanism from being removed until the key lock mechanism is placed in a locked state.

In another alternate embodiment, the retaining function is only performed when a particular authorized key, such as a TSA key, in inserted in to the keyhole and moved to the unlocked position. In this alternate embodiment, the owner of the lock may possess a key which has a different contour from the override key, and may be able to remove the key from the lock cylinder without first rotating the key back to the locked position. However, the TSA override key in this embodiment may not be removed from the lock cylinder without first moving the key back to the locked position. This alternate embodiment permits the lock to remain unlocked but prevents a person with an override or “master” key from leaving the lock in an active or unlocked state. This embodiment further prevents the TSA agent or other authorized person from leaving the key in the key lock (to accommodate other authorized persons inspecting the baggage) with the lock in an unlocked position thereby increasing the risk of loss.

Referring now again to FIGS. 19F-G and 46-50, and in accordance with another embodiment of the present invention, a lock may comprise lock tongues 13 which are made from a flexible material to allow zipper pulls to reengage the lock tongues 13 even though the lock is in a locked position, thereby allowing a user or a TSA agent to relock the zipper pulls Z after a key has been removed from the second lock mechanism. A lock in accordance with this embodiment allows an owner or a TSA agent to reengage the zipper pulls Z with the lock tongues 13 without requiring the position fixing block 1900 and associated parts (such as the first projection 1912, second projection 1916, contacting surface 1920, retaining wall 1928 and retaining surface 1930) described in relation to FIGS. 19A-E, 19H-I and 20A-K above.

According to this embodiment of the present invention, due to the flexible nature of the locking tongues, the sloped contacting surface of the lock tongues 13 allows a zipper pull Z to contact the sloped contacting surface of the lock tongue 13 and thereby deflect the locking tongue 13 laterally and partially within the housing, allowing for zipper pull Z to slide in a generally downward direction past the lock tongue 13 into the receptacle and thereby become engaged with the lock tongue 13 entering the hole H of the zipper pull Z, as best shown in FIGS. 19F-G and 20A-D.

As opposed to the lateral movement of the locking tongues due to contact with the position fixing block 1900, the nature of the flexible material of lock tongue 13 allows the lock tongue 13 to deflect and permit a zipper pull Z to be engaged by the lock tongue 13 with minimal force. The lock tongue 13 according to this embodiment of the invention may be composed of a plastic material of the polyether type, or other thermoplastic material having good physical and processing properties. By way of example, but not limitation, a polyether type plastic such as a plastic formed from a polyacetal resin, such as polyoxymethylene (POM), preferably being a copolymer, may be used as the material for fabricating the lock tongues 13. A material such as POM combines good sliding friction and resilient behavior with high resistance against chemicals and generally very good mechanical properties, thereby allowing a lock tongue 13 to have both the required flexibility to allow deflection (and thereby permit a zipper pull Z to enter the receptacle of the lock shown in FIG. 46), and also have the resilience to withstand damage caused by repeated contact with zipper pull Z to relock the lock once the key has been removed from the second lock mechanism. Its good mechanical properties also provide the lock tongue 13 with good locking qualities which prevent the zipper pulls from being forcibly removed from a locked state. One such copolymer plastic is available commercially for sale from BASF under the trademark “Ultraform.” It is to be expressly understood that other plastics, including other polyacetal structures, may be used with the current embodiment of the invention, and still allow for the locking tongues 13 to deflect in order to permit relocking of a zipper pull Z with the lock after the key has been removed from the second lock mechanism, and securely retain the zipper pull in a locked state until one or more of the locking mechanisms are properly unlocked.

In accordance with the embodiments of the present invention, the locks described above in various forms and body types may further comprise indicia for indicating to authorized personnel, such as TSA agents and consumers, that the lock may be relocked without the insertion of the over-ride key by a TSA agent, or may only allow removal of the key once it has been returned to a locked position, as described in detail above. Such indicia may include, by way of example and not limitation, colors, shapes, words, letters, numbers, or other characters for indicating to a TSA agent that the lock comprises one of the above-described features, such as a keyless relocking feature, thereby eliminating the need to reinsert a key into the lock for relocking, or the need to leave the key in the lock during inspection of the luggage, or obtain the over-ride key from another TSA agent before locking the lock. This simplifies the process for the TSA agents. The indicia also alerts customers when buying locks for their luggage as to features of the particular lock which may be appealing to the customer, given that the feature of being able to relock the lock without the need of the key increases the possibility that the TSA agent will relock the lock and secure the owner's luggage.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

While various embodiments of the present invention have been described in detail, it is apparent that modifications and adaptations of those embodiments will occur to those skilled in the art. However, it is to be expressly understood that such modifications and adaptations are within the spirit and scope of the present invention, as set forth in the following claims.

What is claimed is:

1. A lock comprising:
a housing;
a key lock mechanism having a locked state and an unlocked state, wherein at least a portion of the key lock mechanism is located within the housing and the key lock comprises a key way for receiving a key;
a second lock mechanism having a locked state and an unlocked state, wherein at least a portion of the second lock mechanism is located within the housing;
at least one engaging member for lockably engaging at least one complementary article, the at least one engaging member operatively associated with the key lock mechanism and the second lock mechanism such that the at least one engaging member is moveable away from a locked position upon unlocking at least one of the key lock mechanism and the second lock mechanism to release the at least one complementary article; and
wherein, when the key lock is unlocked by operation of a key positioned in the key way, the at least one engaging member may lockably engage the at least one complementary article with the key removed from the key way.

2. The lock as claimed in claim 1, wherein the at least one engaging member may be relocked with the key removed from the key way and the key lock mechanism in a locked state.

3. The lock as claimed in claim 1, further comprising an activation member operatively associated with the at least one engaging member and movable between a first position and a second position, such that when either of the key lock mechanism or second lock mechanism are in an unlocked state and the activation member is activated, and when the activation member moves from the first position to the second position, the at least one engaging member moves from a locked position to an unlocked position.

4. The lock as claimed in claim 1, wherein the lock is selected from the group consisting of a padlock, a strap lock, a zipper lock and a hard luggage lock.

5. The lock as claimed in claim 1, wherein the at least one engaging member is biased to return to the locked position.

6. The lock as claimed in claim 1, wherein the second lock mechanism is a combination lock mechanism or a key lock mechanism.

7. The lock as claimed in claim 1, further comprising:
an indicator having at least a first normal position and a second revealed position, the indicator at least partially visible when in the second revealed position.

8. The lock as claimed in claim 1, wherein the key may not be removed from said key way unless said key lock mechanism is in said locked state.

9. The lock as claimed in claim 1, wherein said at least one engaging member is made from flexible material and when it is in the locked position deflects to engage the at least one complementary article.

10. The lock as claimed in claim 1, further comprising at least one indicia for indicating that when the lock has been opened by use of a key, the complementary article may be reengaged with the engaging member with the key removed from the key way.

11. The lock as claimed in claim 1, further comprising:
a first biasing member operatively associated with the at least one engaging member,
a second biasing member operatively associated with the first biasing member;
wherein when the key lock mechanism is positioned in the unlocked state and the first biasing member maintains the at least one engaging member in the unlocked state permitting the at least one complementary article to be disengaged from the as least one engaging member with the key removed from the key way; and
when the at least one complementary engaging member is repositioned in the housing, the second biasing member is activated and the first biasing member is released, permitting the at least one engaging member to reengage the at least one complementary article.

12. In a lock having a housing, a key lock mechanism, wherein the key lock mechanism includes a key way, and the key lock mechanism has a locked position and an unlocked position, and an engaging member having a locked position and an unlocked position, for lockably engaging a complementary article when the engaging member is in the locked position, the engaging member operatively associated with the key lock mechanism and movable away from the locked position to the unlocked position when the key lock mechanism is in the unlocked position, the improvement comprising:
the engaging member being made from a flexible material such that the engaging member deflects to lockably engage the complementary article when the engaging member is in the locked position.

13. The lock as claimed in claim 12, further comprising a second lock mechanism operatively associated with the engaging member.

14. The lock as claimed in claim 12, wherein the second lock is a combination lock mechanism or a key lock mechanism.

15. The lock as claimed in claim 12, wherein the lock is selected from the group consisting of a padlock, a strap lock, a zipper lock and a hard luggage lock.

16. The lock as claimed in claim 12, wherein the key lock further comprises a means for preventing removal of the key from the key way unless the key lock mechanism is in a locked position.

17. The lock as claimed in claim 12, wherein the flexible material is comprised of a plastic of the polyether type or a polyacetal resin type.

18. A method for operating a lock to secure a complementary article, the lock including a first key operated locking mechanism, a second lock mechanism and a latch having a first position where the latch engages a complementary article, and a second position where the latch is disengaged from the complementary article, comprising the steps of:
opening the first key operated locking mechanism using a key;
moving the latch to the second position to disengage the complementary article; and
moving the latch to the first position to engage the complementary article by motion of the complementary article.

19. The method as claimed in claim 18, wherein the step of moving the latch to the first position to engage the complementary article by motion of the complementary article is accomplished with the key removed from the first key operated locking mechanism.

20. The method as claimed in claim 18, further comprising relocking the first key operated locking mechanism using the key prior to moving the latch to the first position to engage the complementary article by motion of the complementary article.
